(19) United States
(12) Patent Application Publication
(10) Pub. No.: US 2026/0058545 A1
(43) Pub. Date: Feb. 26, 2026

(54) POWER SUPPLY CONTROL DEVICE

(71) Applicant: ROHM Co., LTD., Kyoto (JP)

(72) Inventors: Shidong Guan, Kyoto (JP); Francois Margallo, Kyoto (JP)

(73) Assignee: ROHM Co., LTD., Kyoto (JP)

(21) Appl. No.: 19/301,311

(22) Filed: Aug. 15, 2025

(30) Foreign Application Priority Data
Aug. 22, 2024 (JP) 2024-140810

(51) Int. Cl. H02M 1/34; H02M 1/00; H02M 1/32; H02M 1/36; H02M 3/158

(52) U.S. Cl. CPC H02M 1/344; H02M 1/0009; H02M 1/327; H02M 1/36; H02M 3/158

(57) ABSTRACT

Provided is a power supply control device provided in a switching power supply apparatus that converts an input voltage into an output voltage through switching of an output transistor, including a switching control circuit that stabilizes the output voltage by switching control of the output transistor, based on a feedback voltage corresponding to the output voltage, a signal output terminal, and a signal output circuit that is capable of outputting a signal corresponding to whether the output voltage is normal from the signal output terminal, based on the feedback voltage, the switching control circuit being capable of performing an overcurrent protecting operation that limits a current flowing through the output transistor to a limit current or less, and the signal output circuit outputting a specific signal indicating execution of the overcurrent protecting operation from the signal output terminal when the current flowing through the output transistor reaches the limit current.

### PRIORITY

The present disclosure contains subject matter related to that disclosed in Japanese Priority Patent Application JP 2024-140810 filed in the Japan Patent Office on Aug. 22, 2024, the entire content of which is hereby incorporated by reference.

### BACKGROUND

The present disclosure relates to a power supply control device.

A switching power supply apparatus that generates an output voltage from an input voltage is widely used. The switching power supply apparatus is provided with a power supply control device (power supply integrated circuit (IC)) for controlling the operation of the switching power supply apparatus. The power supply control device is often configured in a form of a semiconductor integrated circuit. PCT Patent Publication No. WO2021/166389 described below is cited as an example of a document that discloses the power supply control device.

### BRIEF DESCRIPTION OF THE DRAWINGS

FIG. 1 is a general configuration diagram of a power supply device according to an embodiment of the present disclosure;

FIG. 2 is an external perspective view of a power supply control device according to the embodiment of the present disclosure;

FIG. 3 is a diagram of assistance in explaining basic switching control according to the embodiment of the present disclosure;

FIG. 4 is a diagram of assistance in explaining an overcurrent protecting operation according to the embodiment of the present disclosure;

FIG. 5 relates to the embodiment of the present disclosure and is a diagram illustrating two comparators provided within an output monitoring circuit;

FIG. 6 relates to the embodiment of the present disclosure and is a diagram of assistance in explaining a plurality of temperature ranges defined in a temperature detecting circuit;

FIG. 7 relates to a first example belonging to the embodiment of the present disclosure and is a timing diagram of the power supply control device;

FIG. 8 relates to a second example belonging to the embodiment of the present disclosure and is a timing diagram of the power supply control device;

FIG. 9 relates to a third example belonging to the embodiment of the present disclosure and is a timing diagram of the power supply control device;

FIG. 10 relates to a fourth example belonging to the embodiment of the present disclosure and is a general configuration diagram of a power supply device;

FIG. 11 relates to a fifth example belonging to the embodiment of the present disclosure and is a diagram illustrating an example of a specific signal output from a power-good terminal;

FIG. 12 relates to the fifth example belonging to the embodiment of the present disclosure and is a diagram illustrating an example of two kinds of specific signals output from the power-good terminal;

FIG. 13 relates to the fifth example belonging to the embodiment of the present disclosure and is a diagram illustrating a modified method of connection between the power-good terminal and a processor; and

FIG. 14 relates to a sixth example belonging to the embodiment of the present disclosure and is a modified partial configuration diagram of the power supply device.

### DETAILED DESCRIPTION

Examples of an embodiment of the present disclosure will hereinafter specifically be described with reference to figures. In the figures to be referred to, identical parts are identified by the same reference numerals, and repeated description of the identical parts will be omitted in principle. Incidentally, in the present specification, for the simplification of description, the names of information, signals, physical quantities, functional units, circuits, elements, parts, or other relevant items corresponding to symbols or reference numerals may be omitted or abbreviated by writing the symbols or the reference numerals that refer to the information, the signals, the physical quantities, the functional units, the circuits, the elements, the parts, or the other relevant items.

First, a description will be provided for several terms used in describing embodiments of the present disclosure. A ground refers to a reference conductive portion (reference conductor) having a potential (electric potential) of 0 V (zero volts) serving as a reference, or refers to the potential of 0 V itself. The reference conductive portion may be formed using a conductor of metal, for example. The potential of 0 V is sometimes referred to as a ground potential. In the embodiments of the present disclosure, a voltage illustrated without being particularly provided with a reference represents a potential as viewed from the ground.

A level refers to the level (height) of a potential. A high level of any signal or voltage of interest has a potential higher than a low level. In any signal or voltage of interest, a rise edge refers to switching from a low level to a high level, and a fall edge refers to switching from a high level to a low level.

With regard to any transistor configured as a field effect transistor (FET) exemplified by a MOSFET, an on state refers to a state in which there is conduction between the drain and source of the transistor, and an off state refers to a state in which there is no conduction between the drain and source of the transistor (interrupted state). The same applies to transistors not classified as a FET. Unless otherwise specified, a MOSFET is construed as an enhancement type MOSFET. The MOSFET is an abbreviation of “metal-oxide-semiconductor field-effect transistor.” In addition, unless otherwise specified, in any MOSFET, a back gate may be regarded to be short-circuited to a source.

In the following, with regard to any transistor, an on state and an off state may be expressed simply as on and off. In addition, with regard to any transistor, a period in which the transistor is set in an on state will be referred to as an on period, and a period in which the transistor is set in an off state will be referred to as an off period.

With regard to any signal having a signal level of a high level or a low level, a period in which the level of the signal is set to be a high level will be referred to as a high level period, and a period in which the level of the signal is set to be a low level will be referred to as a low level period. The same applies to any voltage having a voltage level of a high level or a low level.

Unless otherwise specified, a connection between a plurality of parts forming a circuit, such as freely-selected circuit elements, wires, or nodes, may be construed as referring to an electric connection.

Supposing that two freely-selected voltages to be compared with each other are voltages v1 and v2, “v1>v2” denotes that the voltage v1 is higher than the voltage v2, “v1<v2” denotes that the voltage v1 is lower than the voltage v2, and “v1=v2” denotes that the value of the voltage v1 is the same as the value of the voltage v2. The same applies to other expressions including physical quantities other than voltages.

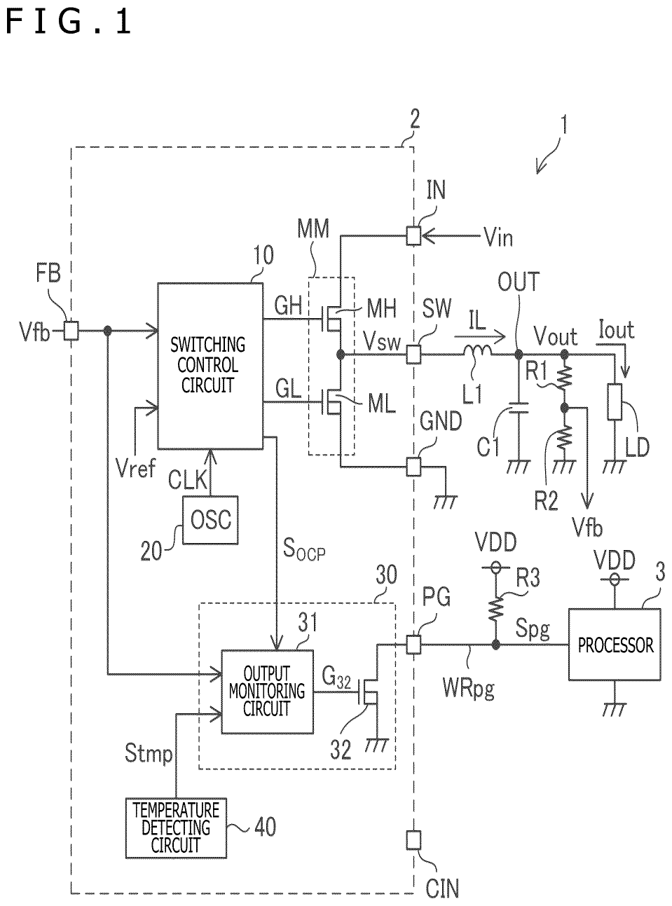

FIG. 1 is a general configuration diagram of a power supply device 1 according to an embodiment of the present disclosure. The power supply device 1 in FIG. 1 includes a power supply control device 2 for controlling operation of the power supply device 1, and also includes a coil L1, an output capacitor C1, feedback resistances R1 and R2, and a pull-up resistor R3 as discrete parts provided outside the power supply control device 2. A processor 3 and a load LD illustrated in FIG. 1 are not constituent elements of the power supply device 1, and are provided outside the power supply device 1. The processor 3 is an example of an external device provided outside the power supply control device 2. The processor 3 is connected to the power supply control device 2. The processor 3 is, for example, a micro controller unit (MCU) or a system on a chip (SOC). Though not apparent from FIG. 1, the power supply control device 2 and the processor 3 may be connected to each other in such a manner as to be capable of two-way communication with each other. As an interface for the two-way communication, a serial peripheral interface (SPI), for example, may be used, or an interface based on an inter-integrated circuit (I²C) or Microwire may be used.

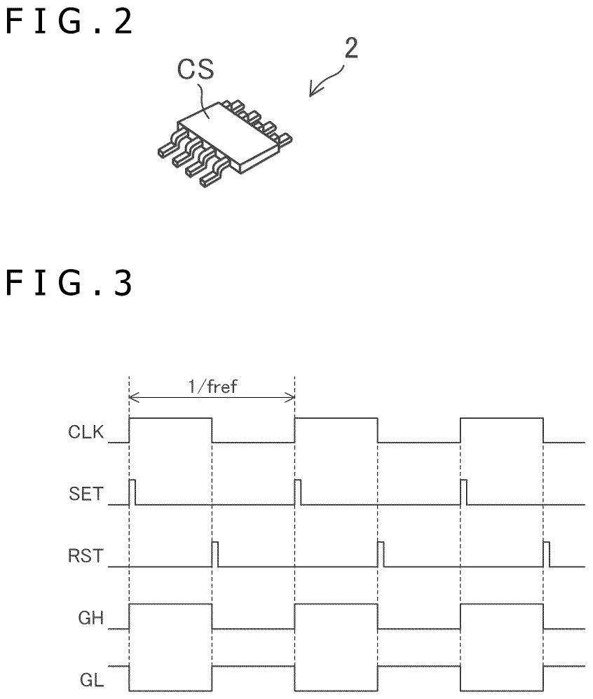

FIG. 2 illustrates an external perspective view of the power supply control device 2. The power supply control device 2 is an electronic part (semiconductor device) including a semiconductor chip having a semiconductor integrated circuit formed on a semiconductor substrate, a casing CS (package) housing the semiconductor chip, and a plurality of external terminals exposed from the casing CS to the outside of the power supply control device 2. The power supply control device 2 is formed by sealing the semiconductor chip within the casing CS formed of resin. It is to be noted that the number of the external terminals of the power supply control device 2 illustrated in FIG. 2 and the type of the casing CS of the power supply control device 2 are merely illustrative, and these may be designed as desired.

The power supply device 1 in FIG. 1 is configured as a step-down switching power supply apparatus (direct-current/direct-current (DC/DC) converter) that generates a desired output voltage Vout from an input voltage Vin supplied from a direct-current voltage source not illustrated. The output voltage Vout occurs at an output terminal OUT. That is, the output terminal OUT is an application terminal of the output voltage Vout (terminal to which the output voltage Vout is applied). The output voltage Vout is supplied to the load LD connected to the output terminal OUT. Except for a transient state, the input voltage Vin and the output voltage Vout are positive direct-current voltages, and the output voltage Vout is lower than the input voltage Vin. When the input voltage Vin is 12 V, for example, the output voltage Vout can be stabilized at a desired positive voltage value (for example, 3.3 V or 5 V) less than 12 V by adjusting the resistance values of the feedback resistances R1 and R2. A current supplied from the output terminal OUT to the load LD will be referred to as a load current Iout. The load current Iout is an output current of the power supply device 1. It is to be noted that the power supply device 1 may be a switching power supply apparatus other than the step-down type, and may be configured as, for example, a step-up or step-up/down switching power supply apparatus.

FIG. 1 illustrates an input terminal IN, a switch terminal SW, a ground terminal GND, a feedback terminal FB, a power-good terminal PG, and an external synchronization terminal CIN as a part of a group of the external terminals provided to the power supply control device 2. The power-good terminal PG is an example of a signal output terminal.

An external configuration of the power supply control device 2 will be described. The input voltage Vin is supplied to the input terminal IN from the direct-current voltage source (not illustrated) provided outside the power supply control device 2. The coil L1 is interposed in series between the switch terminal SW and the output terminal OUT. That is, a first end of the coil L1 is connected to the switch terminal SW, and a second end of the coil L1 is connected to the output terminal OUT. In addition, the output terminal OUT is connected to a ground via the output capacitor C1. That is, a first end of the output capacitor C1 is connected to the output terminal OUT, and a second end of the output capacitor C1 is connected to the ground. Further, the output terminal OUT is connected to a first end of the feedback resistance R1, a second end of the feedback resistance R1 is connected to a first end of the feedback resistance R2, and a second end of the feedback resistance R2 is connected to the ground. A feedback voltage Vfb occurs at a connection node between the feedback resistances R1 and R2. The connection node between the feedback resistances R1 and R2 is connected to the feedback terminal FB. The feedback voltage Vfb is thereby input to the feedback terminal FB. The ground terminal GND is connected to the ground. A current flowing through the coil L1 will be referred to as a coil current IL. The coil current IL in a direction from the switch terminal SW to the output terminal OUT has a positive polarity.

Wiring WRpg is wiring provided outside the power supply control device 2. A first end of the wiring WRpg is connected to the power-good terminal PG, and a second end of the wiring WRpg is connected to an input terminal of the processor 3. A signal in the wiring WRpg will be referred to as a signal Spg. The wiring WRpg is wiring for transmitting the signal Spg to the processor 3. A first end of the pull-up resistor R3 is connected to an application terminal of a power supply voltage VDD (terminal to which the power supply voltage VDD is applied), and a second end of the pull-up resistor R3 is connected to the wiring WRpg. The power supply voltage VDD is a positive direct-current voltage. The processor 3 is connected to the application terminal of the power supply voltage VDD and the ground, and is driven based on the power supply voltage VDD. The power supply voltage VDD may be the output voltage Vout. In this case, the first end of the pull-up resistor R3 is connected to the output terminal OUT. In FIG. 1, the external synchronization terminal CIN is opened. A method of using the external synchronization terminal CIN will be described later. The power supply control device 2 may not be provided with the external synchronization terminal CIN.

An internal configuration of the power supply control device 2 will be described. The power supply control device 2 includes an output stage circuit MM, a switching control circuit 10, an oscillator 20, a signal output circuit 30, and a temperature detecting circuit 40. Besides, circuits for implementing various functions (a low voltage protection circuit, an overvoltage protection circuit, and a reverse current protection circuit, and other circuits) are provided to the power supply control device 2. However, in the following, attention will be directed to the circuits MM, 10, 20, 30, and 40.

The output stage circuit MM includes transistors MH and ML. In the configuration example of FIG. 1, the transistors MH and ML are constituted by an N-channel MOSFET. The transistors MH and ML are a pair of switching elements serially connected between the input terminal IN and the ground terminal GND (in other words, the ground). The transistor MH functions as an output element (output transistor), and the transistor ML functions as a rectifying element (synchronous rectifier transistor). The transistor MH is provided on a higher potential side than the transistor ML. Specifically, a drain of the transistor MH is connected to the input terminal IN as an application terminal of the input voltage Vin, and is supplied with the input voltage Vin. A source of the transistor MH and a drain of the transistor ML are connected in common to the switch terminal SW. A source of the transistor ML is connected to the ground terminal GND (therefore connected to the ground). However, a resistance for current detection may be inserted between the source of the transistor ML and the ground terminal GND.

The switching control circuit 10 switching-controls the output stage circuit MM. The switching control of the output stage circuit MM switches the transistors MH and ML to alternately turn on and off the transistors MH and ML. The switching control of the output stage circuit MM causes a switch voltage Vsw in a rectangular wave shape to appear at the switch terminal SW. The coil L1 and the output capacitor C1 constitute a rectifying and smoothing circuit that generates the output voltage Vout by rectifying and smoothing the switch voltage Vsw in a rectangular wave shape that appears at the switch terminal SW. The feedback resistances R1 and R2 constitute a feedback voltage generating circuit that generates the feedback voltage Vfb corresponding to the output voltage Vout by voltage-dividing the output voltage Vout. The feedback voltage Vfb is proportional to the output voltage Vout. As the output voltage Vout rises or falls, the feedback voltage Vfb also rises or falls.

Incidentally, a modification may be made such that the output voltage Vout itself is used as the feedback voltage Vfb. In either case, the feedback voltage Vfb is a voltage corresponding to the output voltage Vout. In addition, the feedback voltage generating circuit (R1 and R2) may be provided within the power supply control device 2. In this case, the feedback terminal FB is connected to the output terminal OUT.

Gates of the transistors MH and ML are respectively supplied with gate signals GH and GL as driving signals from the switching control circuit 10. The transistors MH and ML are turned on and off according to the gate signals GH and GL. The transistor MH is in an on state during a high level period of the gate signal GH, and the transistor MH is in an off state during a low level period of the gate signal GH. Similarly, the transistor ML is in an on state during a high level period of the gate signal GL, and the transistor ML is in an off state during a low level period of the gate signal GL.

Basically, the transistors MH and ML are alternately turned on and off. However, the transistors MH and ML may both be maintained in an off state. That is, the state of the output stage circuit MM is one of an output high state, an output low state, and a double off state. In the output high state, the transistor MH is in an on state, and the transistor ML is in an off state. In the output low state, the transistor MH is in an off state, and the transistor ML is in an on state. In the double off state, the transistors MH and ML are both in an off state. The transistors MH and ML are not simultaneously set in an on state. In the switching control by the switching control circuit 10, alternately turning on and off the transistors MH and ML is a concept including the intervention of the double off state with a dead time or other factor taken into consideration during a transition between the output low state and the output high state. Incidentally, at least one of the transistors MH and ML may be provided outside the power supply control device 2. The whole of the output stage circuit MM may be provided outside the power supply control device 2 and connected to the power supply control device 2.

The switching control circuit 10 is connected to the feedback terminal FB and receives the feedback voltage Vfb. The switching control circuit 10 controls the respective on/off states of the transistors MH and ML through level control on the gate signals GH and GL based on the feedback voltage Vfb. The switching control circuit 10 thereby makes a desired output voltage Vout generated at the output terminal OUT. A reference voltage Vref having a predetermined positive direct-current voltage value is generated within the power supply control device 2. The switching control circuit 10 performs switching control of the output stage circuit MM such that the feedback voltage Vfb coincides with the reference voltage Vref. When the feedback voltage Vfb coincides with the reference voltage Vref, the output voltage Vout coincides with a predetermined target voltage Vtg. That is, the switching control circuit 10 performs switching control of the output stage circuit MM, based on the feedback voltage Vfb, to stabilize the output voltage Vout at the target voltage Vtg (to reduce a difference between the output voltage Vout and the target voltage Vtg).

A control system for stabilizing the output voltage Vout at the target voltage Vtg may be selected as desired. The present embodiment takes an example in which a pulse width modulation system is adopted in the control system. The switching control circuit 10 adopting the pulse width modulation system controls an output duty of the output stage circuit MM. At this time, the switching control circuit 10 performs feedback control that increases the output duty of the output stage circuit MM when “Vfb<Vref” and decreases the output duty of the output stage circuit MM when “Vfb>Vref.” The output duty of the output stage circuit MM is a ratio of an on period of the transistor MH to a sum of the on period of the transistor MH and an off period of the transistor MH. In addition, in the control system for stabilizing the output voltage Vout at the target voltage Vtg, a pulse frequency modulation system may be adopted, or a constant on-time control system may be adopted.

The oscillator 20 generates a clock signal CLK having a predetermined reference frequency fref. The clock signal CLK is a rectangular wave signal alternately having a high level and a low level. The clock signal CLK is input to the switching control circuit 10.

The switching control circuit 10 performs basic switching control illustrated in FIG. 3 in principle (exceptions will be described later). Signals SET and RST illustrated in FIG. 3 are generated within the switching control circuit 10. Each of the signals SET and RST is a binary signal having a high level or a low level. A pulse width modulated signal is formed by the signals SET and RST. A single pulse width modulated signal indicating the contents of the signals SET and RST may be generated within the switching control circuit 10. The signals SET and RST have a low level in principle. In the basic switching control, the switching control circuit 10 generates a rise edge in the signal SET at the timing of the occurrence of a rise edge in the clock signal CLK, and generates a rise edge in the signal RST at the timing based on a feedback control signal not illustrated. The feedback control signal is generated by the switching control circuit 10 according to an error between the feedback voltage Vfb and the reference voltage Vref. The feedback control signal can be generated also based on the magnitude of the coil current IL. The lengths of respective high level periods of the signals SET and RST are minute, and are sufficiently shorter than the cycle of the clock signal CLK. The signal SET having a high level is a signal commanding the state of the output stage circuit MM to be set to the output high state. The signal RST having a high level is a signal commanding the state of the output stage circuit MM to be set to the output low state.

In the basic switching control, the switching control circuit 10 repeats the following unit operation. In the unit operation, the switching control circuit 10 switches the state of the output stage circuit MM from the output low state to the output high state at the timing of the occurrence of a rise edge in the signal SET, and then switches the state of the output stage circuit MM from the output high state to the output low state at the timing of the occurrence of a rise edge in the signal RST. The switching control circuit 10 controls the output duty of the output stage circuit MM by generating the feedback control signal such that an error between the feedback voltage Vfb and the reference voltage Vref approaches zero. Hence, the signals SET and RST are a switching control signal that commands and controls the state of the output stage circuit MM, and the switching control signal is derived at least based on the feedback voltage Vfb to reduce the error between the feedback voltage Vfb and the reference voltage Vref (such that the feedback voltage Vfb coincides with the reference voltage Vref). Incidentally, the duty of the clock signal CLK is set as desired.

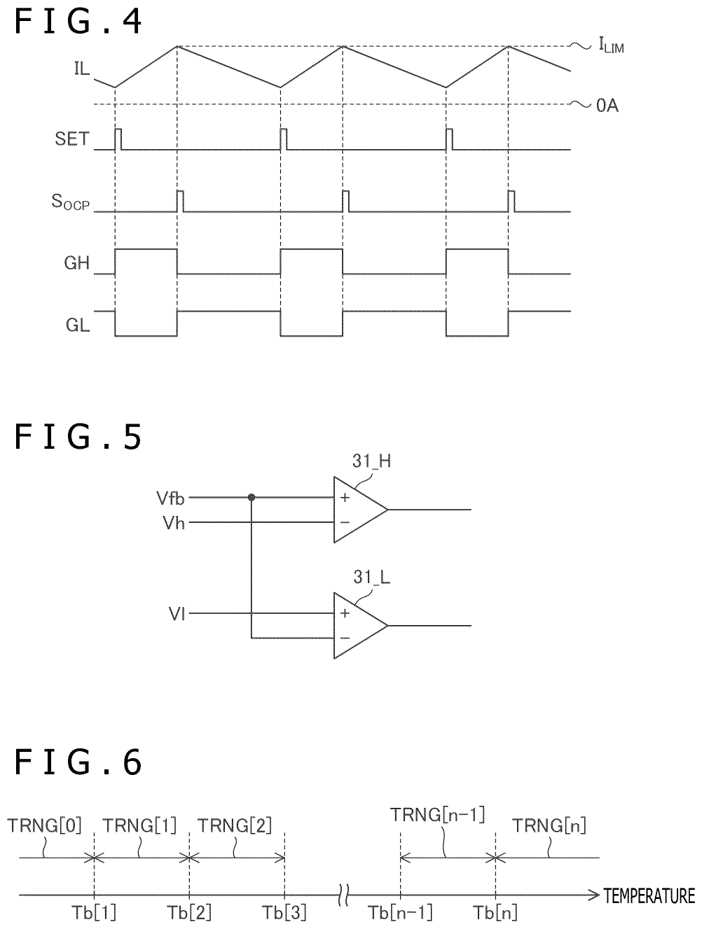

The switching control circuit 10 is capable of performing an overcurrent protecting operation. The overcurrent protecting operation will be described with reference to FIG. 4. At a light load (when the load current Iout is fairly small), a timing at which the coil current IL becomes negative can occur. However, here, the power supply device 1 is assumed to operate in a continuous mode in which the coil current IL has a positive value at all times. In a period in which the output stage circuit MM is in the output high state, the coil current IL flows through the drain and source of the transistor MH. The coil current IL in the on period of the transistor MH is therefore equal to a drain current of the transistor MH. In a period in which the output stage circuit MM is in the output low state, the coil current IL flows through the drain and source of the transistor ML.

The coil current IL gradually increases in a period in which the output stage circuit MM is in the output high state (that is, an on period of the transistor MH). The coil current IL gradually decreases in a period in which the output stage circuit MM is in the output low state (that is, an on period of the transistor ML). The overcurrent protecting operation limits the coil current IL (hence, the drain current of the transistor MH in the on period of the transistor MH) to a limit current I_{LIM} or less. The switching control circuit 10 in the overcurrent protecting operation detects the magnitude of the coil current IL in the on period of the transistor MH, and monitors whether or not the coil current IL in the on period of the transistor MH (hence, the drain current of the transistor MH) reaches the limit current I_{LIM}. The switching control circuit 10 generates an overcurrent protection signal S_{OCP} as a signal indicating a result of the monitoring. The limit current I_{LIM} has a predetermined positive current value.

A method of detecting the coil current IL may be selected as desired. For example, in the on period of the transistor MH, the switching control circuit 10 can detect the coil current IL, based on an on resistance of the transistor MH known to the power supply control device 2 and a drain-to-source voltage of the transistor MH. Alternatively, for example, in the on period of the transistor MH, the coil current IL may be detected through detection of a current flowing through a replica transistor connected in parallel with the transistor MH. Alternatively, for example, a shunt resistance (not illustrated) may be connected in series with the transistor MH in advance, and the coil current IL may be detected based on a voltage drop across the shunt resistance.

The overcurrent protection signal S_{OCP} is a binary signal having a high level or a low level. The switching control circuit 10 sets the overcurrent protection signal S_{OCP} to a low level in principle, and sets the overcurrent protection signal S_{OCP} to a high level for a minute time when the coil current IL (hence, the drain current of the transistor MH) reaches the limit current I_{LIM} in the on period of the transistor MH. The switching control circuit 10 may provide the overcurrent protection signal S_{OCP} with a high level for a period in which the coil current IL is equal to or more than the limit current I_{LIM}. When a rise edge occurs in the overcurrent protection signal S_{OCP} after the switching control circuit 10 sets the output stage circuit MM to the output high state with a rise edge in the signal SET as a trigger, the switching control circuit 10 immediately switches the output stage circuit MM from the output high state to the output low state without waiting for the occurrence of a rise edge in the signal RST (that is, irrespective of the switching control signal). When the next rise edge in the signal SET thereafter occurs, the switching control circuit 10 sets the output stage circuit MM to the output high state again. Such an overcurrent protecting operation limits the coil current IL (hence, the drain current of the transistor MH) to the limit current I_{LIM} or less.

The signal output circuit 30 is connected to the power-good terminal PG, and outputs the signal Spg from the power-good terminal PG in cooperation with the pull-up resistor R3. The signal output circuit 30 includes an output monitoring circuit 31 and a transistor 32. The transistor 32 is an N-channel MOSFET having an open drain configuration. That is, a drain of the transistor 32 is connected to the power-good terminal PG, and a source of the transistor 32 is connected to the ground. The output monitoring circuit 31 is connected to a gate of the transistor 32, and supplies the gate of the transistor 32 with a gate signal G₃₂ having a high level or a low level. The transistor 32 is on when the gate signal G₃₂ has a high level. The transistor 32 is off when the gate signal G₃₂ has a low level. Hence, the output monitoring circuit 31 controls the transistor 32 to an off state by supplying the gate of the transistor 32 with the gate signal G₃₂ having a low level, and controls the transistor 32 to an on state by supplying the gate of the transistor 32 with the gate signal G₃₂ having a high level. When the transistor 32 is in an off state, the signal Spg has a high level (level of the power supply voltage VDD). When the transistor 32 is in an on state, the signal Spg has a low level (level of 0 V).

Main processing performed by the signal output circuit 30 is output monitoring processing. In the output monitoring processing, the output monitoring circuit 31 determines based on the feedback voltage Vfb whether or not the output voltage Vout falls within a predetermined normal voltage range RNG_{NML}. The normal voltage range RNG_{NML} is a voltage range equal to or higher than a predetermined normal lower limit voltage V_L but equal to or lower than a predetermined normal upper limit voltage V_H. The normal lower limit voltage V_L is lower than the target voltage Vtg. The normal upper limit voltage V_H is higher than the target voltage Vtg. For example, “V_L=Vtg×(1−k_{A})” and “V_H=Vtg×(1+k_{A}).” Here, k_{A} is a predetermined positive coefficient (for example, 0.03) sufficiently smaller than 1.

Specifically, it suffices to provide the output monitoring circuit 31 with comparators 31_H and 31_L illustrated in FIG. 5. The comparator 31_H compares the feedback voltage Vfb with a determination voltage Vh. The comparator 31_L compares the feedback voltage Vfb with a determination voltage Vl. Here, the determination voltages Vh and Vl have positive direct-current voltage values satisfying “Vl<Vh.” The comparators 31_H and 31_L form a window comparator that determines whether or not “Vl≤Vfb≤Vh” holds.

The output monitoring circuit 31 determines that the output voltage Vout falls within the normal voltage range RNG_{NML} (that is, determines that “V_L≤Vout≤V_H” holds) when “Vl≤Vfb≤Vh” holds. In the output monitoring processing, the output monitoring circuit 31 holds the signal Spg at a high level by controlling the transistor 32 to an off state in a period in which the output voltage Vout is determined to fall within the normal voltage range RNG_{NML} (that is, in a period in which “V_L≤Vout≤V_H” holds) (however, there is an exception to be described later). The output monitoring circuit 31 determines that the output voltage Vout deviates from the normal voltage range RNG_{NML} (that is, determines that “V_L≤Vout≤V_H” does not hold) when “Vl≤Vfb≤Vh” does not hold. In the output monitoring processing, the output monitoring circuit 31 holds the signal Spg at a low level by controlling the transistor 32 to an on state in a period in which the output voltage Vout is determined to deviate from the normal voltage range RNG_{NML} (that is, in a period in which “V_L≤Vout≤V_H” does not hold) (however, there is an exception to be described later).

The processor 3 can recognize whether or not the output voltage Vout is normal, based on the level of the signal Spg. The signal Spg having a high level derived by the output monitoring processing indicates that the output voltage Vout is normal. The signal Spg having a low level derived by the output monitoring processing indicates that the output voltage Vout is abnormal (that is, indicates that the output voltage Vout is not normal). An abnormality of the output voltage Vout refers to, for example, a state in which an error between the output voltage Vout and the target voltage Vtg is larger than a product of the output voltage Vout and a fixed coefficient (for example, 3%).

Incidentally, the above-described overcurrent protection signal S_{OCP} is supplied to the output monitoring circuit 31. A method of using the overcurrent protection signal S_{OCP} by the output monitoring circuit 31 will be described later.

The temperature detecting circuit 40 detects a temperature at a measurement target position, and generates a temperature detection signal Stmp corresponding to the temperature at the measurement target position (detected temperature at the measurement target position). The temperature at the measurement target position will be referred to as a target temperature TMP. A reference will be made to FIG. 6. The temperature detecting circuit 40 defines a total of (n+1) temperature ranges TRNG[0] to TRNG[n]. n may be 1 or 2. n may be any integer of 3 or more. The temperature ranges TRNG[0] to TRNG[n] do not overlap. For any integer i, the temperature range TRNG[i+1] is higher than the temperature range TRNG[i]. That is, all temperatures belonging to the temperature range TRNG[i+1] are higher than all temperatures belonging to the temperature range TRNG[i]. A temperature Tb[i] is a temperature at a boundary between the temperature range TRNG[i−1] and the temperature range TRNG[i]. For any integer i, the temperature Tb[i+1] is higher than the temperature Tb[i].

The temperature range TRNG[0] is a temperature range lower than the temperature Tb[1]. That is, temperatures lower than the temperature Tb[1] all belong to the temperature range TRNG[0]. The temperature range TRNG[1] is a temperature range equal to or higher than the temperature Tb[1] but lower than the temperature Tb[2]. The temperature range TRNG[2] is a temperature range equal to or higher than the temperature Tb[2] but lower than the temperature Tb[3]. The same applies to other temperature ranges. That is, when i is assumed to represent any natural number equal to or less than (n−1), the temperature range TRNG[i] is a temperature range equal to or higher than the temperature Tb[i] but lower than the temperature Tb[i+1]. The temperature range TRNG[n] is a temperature range equal to or higher than the temperature Tb[n]. That is, temperatures equal to or higher than the temperature Tb[n] all belong to the temperature range TRNG[n].

The temperature detecting circuit 40 is provided with a temperature measuring element (not illustrated) for detecting the target temperature TMP. The temperature measuring element is disposed at the measurement target position, and outputs a signal corresponding to the target temperature TMP in cooperation with a circuit connected to the temperature measuring element. For example, the temperature measuring element is installed at a position suitable for measuring the temperature of the transistor MH or ML. At this time, the temperature measuring element is disposed at a position in proximity to the transistor MH or ML. A silicon diode can be used as the temperature measuring element. The target temperature TMP can be detected using the temperature characteristics of a forward voltage of the diode. The target temperature TMP may be detected using a base-to-emitter voltage of a bipolar transistor in place of the forward voltage of the diode.

The temperature detecting circuit 40 generates the temperature detection signal Stmp, based on the output signal of the temperature measuring element. The temperature detecting circuit 40 detects to which of the temperature ranges TRNG[0] to TRNG[n] the target temperature TMP belongs, based on the output signal of the temperature measuring element, and outputs a result of the detection as the temperature detection signal Stmp. The temperature detection signal Stmp is a digital signal indicating to which of the temperature ranges TRNG[0] to TRNG[n] the target temperature TMP belongs. When “n=3,” for example, the temperature detection signal Stmp can be formed by a digital signal of 2 bits. When “n=3,” the temperatures Tb[1], Tb[2], and Tb[3] can be set to be 125° C., 150° C., and 175° C., respectively. However, specific values of the temperature Tb[i] are not limited to this, and n may be other than 3.

Incidentally, though not particularly illustrated in the figure, the power supply control device 2 is provided with an internal power supply circuit that generates an internal power supply voltage, based on the input voltage Vin. The circuits within the power supply control device 2 are driven based on the input voltage Vin or the internal power supply voltage. In addition, whereas the gate signal GL is a signal having a ground potential as a reference, the gate signal GH is a signal having the potential of the switch terminal SW as a reference. The gate signal GH at a low level has the potential of the switch terminal SW. The gate signal GH at a high level is higher by a predetermined voltage as viewed from the potential of the switch terminal SW. The predetermined voltage here is higher than a gate threshold voltage of the transistor MH. A boosting power supply for generating the gate signal GH can be created using a well-known bootstrap circuit (not illustrated). The transistor MH may be constituted by a P-channel MOSFET. In that case, the boosting power supply is unnecessary.

In addition, as a modification, a diode rectification system may be adopted in the power supply device 1. In this case, as the rectifying element, a synchronous rectifier diode having an anode connected to the ground terminal GND and a cathode connected to the switch terminal SW is provided to the power supply device 1 in place of the transistor ML. In this case, only the transistor MH is turned on and off in the switching control of the output stage circuit MM. In either case, the input voltage Vin is converted into the output voltage Vout through the switching of the transistor MH (output transistor) between on and off in the switching control of the output stage circuit MM.

Incidentally, even when some abnormality or a specific condition has occurred within the power supply control device 2 during the execution of an operation of generating the output voltage Vout by using the power supply control device 2, it is not generally easy to determine the occurrence from the outside of the power supply control device 2. The occurrence of the abnormality or the specific condition can be clearly communicated to the outside when a dedicated external terminal is provided to the power supply control device 2. However, the installation of the dedicated external terminal leads to an increase in the size and cost of parts of the power supply control device 2, and in turn leads also to an increase in the size and cost of the whole of the power supply device 1.

The power supply control device 2 according to the present embodiment has a function of communicating the occurrence of various kinds of abnormalities or specific conditions to the external device by using the power-good terminal PG originally installed to monitor the output voltage Vout.

In the following, several specific operation examples, applied technologies, modified technologies, and other technologies related to the above-described function will be described in a plurality of examples. The items described above in the present embodiment are applied to each of the following examples unless otherwise specified and unless there is an inconsistency. In a case where there are items inconsistent with the items described above in the examples, the description in the examples may be given priority. In addition, as long as there is no inconsistency, an item described in a freely-selected example among the plurality of examples to be illustrated in the following can be applied to another freely-selected example (that is, two or more freely-selected examples among the plurality of examples can be combined with each other).

### First Example

A first example will be described. With regard to an ordinary power supply control device, even when an overcurrent protecting operation is exerted within the power supply control device, it is difficult to determine from the outside of the power supply control device that the overcurrent protecting operation is exerted. When the overcurrent protecting operation is exerted within the power supply control device, it would be useful if it can be determined in a device external to the power supply control device that the overcurrent protecting operation is exerted. For example, based on the determined content, a designer of the power supply device can, for example, consider lowering the input voltage or changing the capacitance of the output capacitor such that the overcurrent protecting operation is not readily exerted. When the overcurrent protecting operation is exerted, the power supply control device 2 in FIG. 1 outputs a signal to that effect to the external device (processor 3) by using the power-good terminal PG. This will be described specifically.

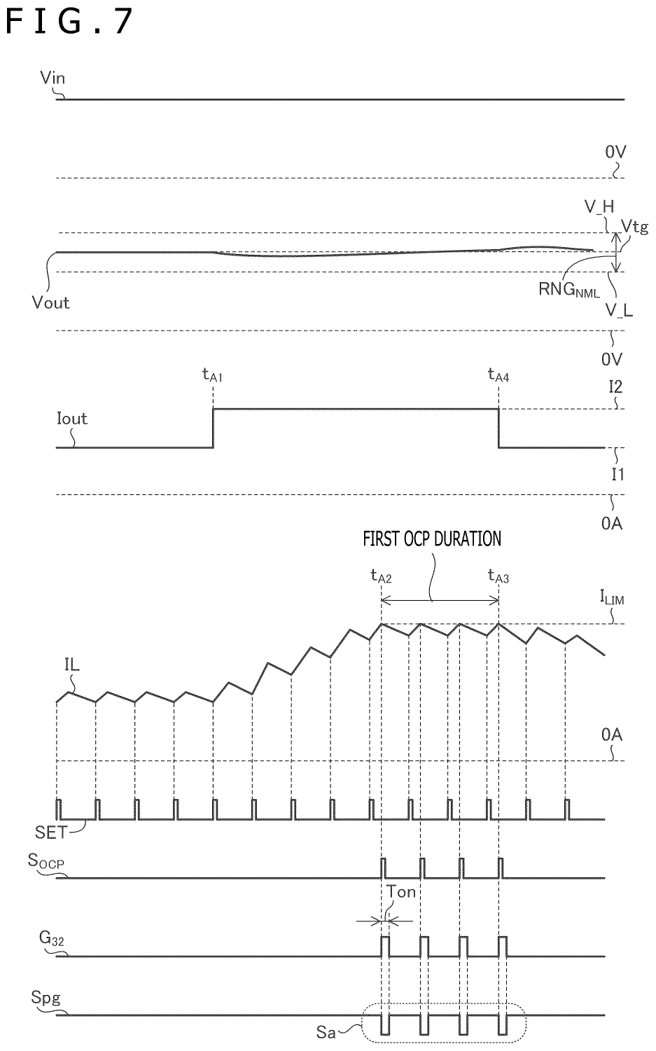

Conditions illustrated in FIG. 7 are assumed. Under the conditions illustrated in FIG. 7, while the input voltage VIN is maintained to be a sufficiently high voltage and the output voltage Vout is stabilized at and in the vicinity of the target voltage Vtg, the value of the load current Iout sharply increases from a current value I1 to a current value I2 at time t_{A1}, and thereafter sharply decreases to the current value I1 at time t_{A4} (I1<I2). In the period in which the load current Iout has the current value I2, an average value of the coil current IL gradually increases. Time t_{A2} is a time after time t_{A1} but before time t_{A4}. At time t_{A2}, the coil current IL reaches the limit current I_{LIM} for the first time in a state in which the transistor MH is on. Therefore, a rise edge occurs in the overcurrent protection signal S_{OCP} at time t_{A2}, and the overcurrent protecting operation switches the state of the output stage circuit MM from the output high state to the output low state immediately. Incidentally, the average value of the coil current IL refers to an average value of the coil current IL in each switching cycle of the output stage circuit MM.

Also after time t_{A2} and until time t_{A3} in the vicinity of time t_{A4}, each time the transistor MH is switched from off to on, the coil current IL reaches the limit current I_{LIM} through an increase in the coil current IL in the on period of the transistor MH, and the overcurrent protecting operation immediately switches the state of the output stage circuit MM from the output high state to the output low state irrespective of the signal RST (that is, irrespective of the switching control signal). Time t_{A3} is a time after time t_{A2}. Time t_{A3} may be a time before time t_{A4}, or may be a time after time t_{A4}. First reaching of the limit current I_{LIM} by the coil current IL occurs at time t_{A2}, and jth reaching of the limit current I_{LIM} by the coil current IL occurs at time t_{A3}. In the example of FIG. 7, “j=4.” However, j represents any integer of 2 or more, and, in practice, often has an integer value sufficiently larger than 2 (for example, hundreds to tens of thousands). That is, in a period between times t_{A2} and t_{A3}, the reaching of the limit current I_{LIM} by the coil current IL occurs repeatedly, and the number of times of the reaching is various.

A rise edge occurs in the overcurrent protection signal S_{OCP} each time the coil current IL reaches the limit current I_{LIM} in a state in which the transistor MH is on. Under the conditions illustrated in FIG. 7, in a period between times t_{A2} and t_{A3}, a rise edge occurs in the overcurrent protection signal S_{OCP} once in each switching period of the output stage circuit MM. The overcurrent protection signal S_{OCP} therefore has the same frequency as the frequency of the signal SET (hence, the same frequency as the switching frequency of the transistors MH and ML).

The output monitoring circuit 31 can control the transistor 32 to an on state, based on the overcurrent protection signal S_{OCP} at a high level, even when the output voltage Vout falls within the normal voltage range RNG_{NML}. Suppose that, under the conditions illustrated in FIG. 7, the output voltage Vout falls within the normal voltage range RNG_{NML} from a time before time t_{A1} to a time after times t_{A3} and t_{A4}.

As a basic operation related to the monitoring of the output voltage, the signal output circuit 30 holds the signal Spg at a high level through the setting and maintaining of the transistor 32 in an off state in a period in which the output voltage Vout falls within the normal voltage range RNG_{NML} and the coil current IL (drain current of the transistor MH in the on period of the transistor MH) is maintained to be smaller than the limit current I_{LIM}, and holds the signal Spg at a low level through the setting and maintaining of the transistor 32 in an on state in a period in which the output voltage Vout deviates from the normal voltage range RNG_{NML} and the coil current IL (drain current of the transistor MH in the on period of the transistor MH) is maintained to be smaller than the limit current I_{LIM}.

However, in a period in which the switching of the transistor MH to an off state by the overcurrent protecting operation is performed repeatedly (the period will hereinafter be referred to as a first OCP duration), the signal output circuit 30 performs an operation of outputting a specific signal Sa indicating that the overcurrent protecting operation is performed, as the signal Spg, from the power-good terminal PG, preferentially over the above-described basic operation. The specific signal Sa is a rectangular wave signal alternately having a high level and a low level. The period between times t_{A2} and t_{A3} in FIG. 7 is an example of the first OCP duration. Incidentally, the rectangular wave signal as the signal Spg may have a waveform rounded depending on the value of the pull-up resistor R3 and a capacitance added to the wiring WRpg (including a parasitic capacitance), for example.

In the first OCP duration, each time the transistor MH is switched from off to on with a rise edge in the signal SET as a trigger, the coil current IL (drain current of the transistor MH) reaches the limit current I_{LIM} through an increase in the coil current IL in the on period of the transistor MH. Hence, in the first OCP duration, each time the state of the output stage circuit MM is switched from the output low state to the output high state, the overcurrent protecting operation switches the state of the output stage circuit MM from the output high state to the output low state irrespective of the signal RST (that is, irrespective of the switching control signal) after the switching to the output high state.

In the first OCP duration, the signal output circuit 30 may output a rectangular wave signal (specific signal Sa) alternately having a high level and a low level, as the signal Spg, from the power-good terminal PG irrespective of whether or not the output voltage Vout falls within the normal voltage range RNG_{NML}. Alternatively, when the output voltage Vout deviates from the normal voltage range RNG_{NML}, the signal output circuit 30 may constantly output the signal Spg having a low level through the setting and maintaining of the transistor 32 in an on state irrespective of whether or not a present time belongs to the first OCP duration (that is, irrespective of the overcurrent protection signal S_{OCP}).

The specific signal Sa that can be output by the signal output circuit 30 in the first OCP duration may be a rectangular wave signal having a predetermined frequency f_{X}. The predetermined frequency f_{X} here may be any frequency set independently of the switching frequency of the output stage circuit MM, or may be a frequency proportional to the switching frequency of the output stage circuit MM. The same frequency as the switching frequency of the output stage circuit MM also belongs to frequencies proportional to the switching frequency of the output stage circuit MM.

In the example of FIG. 7, in the first OCP duration corresponding to a period between times t_{A2} and t_{A3}, the output monitoring circuit 31 sets the transistor 32 to off (hence sets the signal Spg to a high level) by setting the gate signal G₃₂ to a low level in principle, generates a rise edge in the gate signal G₃₂ each time a rise edge occurs in the overcurrent protection signal S_{OCP}, and thereafter generates a fall edge in the gate signal G₃₂ when an on time Ton passes. Hence, each time a rise edge occurs in the overcurrent protection signal S_{OCP}, the transistor 32 is turned on for the on time Ton, and the signal Spg thereby has a low level for the on time Ton. As a result, the specific signal Sa in the example of FIG. 7 is a rectangular wave signal having the same frequency as the switching frequency of the output stage circuit MM. The on time Ton may be a predetermined fixed time. Alternatively, a time for which the overcurrent protection signal S_{OCP} has a high level may be the on time Ton. However, suppose that the on time Ton is shorter than a switching cycle of the output stage circuit MM (in other words, a reciprocal of the switching frequency of the output stage circuit MM).

According to the method in the first example, whether the overcurrent protecting operation is exerted within the power supply control device 2 can be determined by referring to the signal Spg. Based on the determined content, the designer of the power supply device 1 can, for example, consider lowering the input voltage Vin or changing the capacitance of the output capacitor C1 such that the overcurrent protecting operation is not readily exerted. An improvement in convenience in the design of the power supply device 1 is consequently achieved.

### Second Example

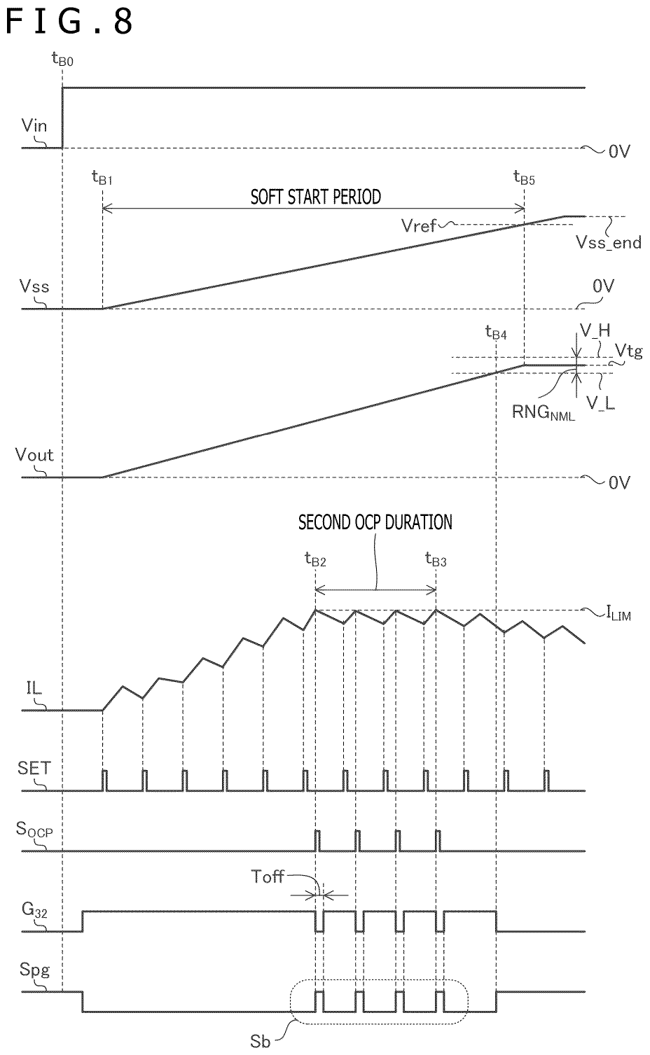

A second example will be described. The power supply control device 2 is provided with a soft start function. The soft start function is a function of gradually raising the output voltage Vout from 0 V to the target voltage Vtg. The switching control circuit 10 generates a voltage Vss for implementing the soft start function. With reference to FIG. 8, a description will be made of the soft start function and the overcurrent protecting operation that can be performed in a process in which the output voltage Vout rises from 0 V to the target voltage Vtg. Suppose that, in the example of FIG. 8, times t_{B0}, t_{B1}, t_{B2}, t_{B3}, t_{B4}, and t_{B5} arrive in this order with the progress of time.

The supply of the input voltage Vin to the input terminal IN is shut off before time t_{B0}. The supply of the input voltage Vin to the input terminal IN is started from time t_{B0}. After time t_{B0}, the input voltage Vin supplied to the input terminal IN is sufficiently higher than the target voltage Vtg. The power supply control device 2 is started at time t_{B0}, and a predetermined initial sequence operation is performed within the power supply control device 2 from time t_{B0}. In the initial sequence operation, the output monitoring circuit 31 sets the transistor 32 to on by setting the level of the gate signal G₃₂ to a high level. Because the transistor 32 is set to on, the signal Spg has a low level. Though different from the conditions illustrated in FIG. 8, if the overcurrent protecting operation is not thereafter performed, the output monitoring circuit 31 holds the signal Spg at a low level by maintaining the level of the gate signal G₃₂ at a high level until a time point (which corresponds to time t_{B4}) at which the output voltage Vout reaches the normal lower limit voltage V_L through a rise from 0 V, and holds the signal Spg at a high level by maintaining the level of the gate signal G₃₂ at a low level as long as the output voltage Vout falls within the normal voltage range RNG_{NML}.

Time t_{B1} is reached after completion of the initial sequence operation. Until time t_{B1}, switching control by the switching control circuit 10 is stopped and the output stage circuit MM is held in the double off state. The switching control circuit 10 starts the switching control of the output stage circuit MM from time t_{B1}. The voltage Vss is 0 V at time t_{B1}, and monotonically rises at a predetermined rate of change from time t_{B1}. However, after the voltage Vss reaches a predetermined upper limit voltage Vss_end, the voltage Vss is maintained at the upper limit voltage Vss_end. The upper limit voltage Vss_end is higher than the reference voltage Vref described above.

In the above case, a description has been made of the switching control of the output stage circuit MM performed such that the feedback voltage Vfb coincides with the reference voltage Vref. Specifically, however, the switching control aimed at “Vfb=Vref” is switching control in a period in which “Vss≥Vref” holds. That is, specifically, the switching control circuit 10 compares the lower of the reference voltage Vref and the voltage Vss (the lower voltage will hereinafter be referred to as a comparative voltage Va for convenience) with the feedback voltage Vfb. The switching control circuit 10 performs the switching control of the output stage circuit MM such that the feedback voltage Vfb coincides with the comparative voltage Va. The switching control circuit 10 performs feedback control that increases the output duty of the output stage circuit MM when “Vfb<Va” and that decreases the output duty of the output stage circuit MM when “Vfb>Va.” The feedback control signal described above is generated by the switching control circuit 10 according to an error between the feedback voltage Vfb and the comparative voltage Va. The switching control circuit 10 controls the output duty by generating the feedback control signal such that the error between the feedback voltage Vfb and the comparative voltage Va approaches zero. In a period in which “Vss<Vref” holds, the switching control aimed at “Vfb=Vss” is performed, and hence, the output voltage Vout gradually rises to the target voltage Vtg. In the example of FIG. 8, “Vss<Vref” holds before time t_{B5}, “Vss=Vref” holds at time t_{B5}, and “Vss>Vref” holds after time t_{B5}.

When the switching control of the output stage circuit MM is started at time t_{B1}, the output voltage Vout gradually rises from 0 V while being accompanied by an increase in the average value of the coil current IL. In the example of FIG. 8, at time t_{B2}, the coil current IL reaches the limit current I_{LIM} for the first time in a state in which the transistor MH is on. A rise edge therefore occurs in the overcurrent protection signal S_{OCP} at time t_{B2}. Thus, the overcurrent protecting operation immediately switches the state of the output stage circuit MM from the output high state to the output low state.

Also after time t_{B2} and until time t_{B3}, each time the transistor MH is switched from off to on, the coil current IL reaches the limit current I_{LIM} through an increase in the on period of the transistor MH, and the overcurrent protecting operation immediately switches the state of the output stage circuit MM from the output high state to the output low state irrespective of the signal RST (that is, irrespective of the switching control signal). First reaching of the limit current I_{LIM} by the coil current IL occurs at time t_{B2}, and jth reaching of the limit current I_{LIM} by the coil current IL occurs at time t_{B3}. In the example of FIG. 8, “j=4.” However, j represents any integer of 2 or more, and in practice, often has an integer value sufficiently larger than 2 (for example, hundreds to tens of thousands). That is, in a period between times t_{B2} and t_{B3}, the reaching of the limit current I_{LIM} by the coil current IL occurs repeatedly, and the number of times of the reaching is various.

A rise edge occurs in the overcurrent protection signal S_{OCP} each time the coil current IL reaches the limit current I_{LIM} in a state in which the transistor MH is on. Under the conditions illustrated in FIG. 8, in a period between times t_{B2} and t_{B3}, a rise edge occurs in the overcurrent protection signal S_{OCP} once in each switching period of the output stage circuit MM. The overcurrent protection signal S_{OCP} hence has the same frequency as the frequency of the signal SET (hence, the same frequency as the switching frequency of the transistors MH and ML).

A period from the time point of a start of the switching control of the output stage circuit MM to the holding of “Vss=Vref,” that is, a period between times t_{B1} and t_{B5}, will be referred to as a soft start period. Incidentally, “Vss>Vref” holds in a period after time t_{A1} illustrated in the first example (see FIG. 7), and hence, the period after time t_{A1} does not correspond to the soft start period.

In the soft start period, the output voltage Vout gradually rises from 0 V to the target voltage Vtg as the voltage Vss rises. The output monitoring circuit 31 in the soft start period can control the transistor 32 to an off state, based on the overcurrent protection signal S_{OCP} at a high level, even when the output voltage Vout is lower than the normal lower limit voltage V_L as a lower limit of the normal voltage range RNG_{NML}. Under the conditions illustrated in FIG. 8, the output voltage Vout monotonically rises in a period between times t_{B1} and t_{B5}, “Vout<V_L” holds from time t_{B1} through times t_{B2} and t_{B3} to a time immediately before time t_{B4}, “Vout=V_L” holds at time t_{B4}, “Vref=Vss” and the output voltage Vout reaches the target voltage Vtg at time t_{B5}, and the output voltage Vout is stabilized at the target voltage Vtg after time t_{B5}.

As a basic operation related to the monitoring of the output voltage, the signal output circuit 30 holds the signal Spg at a high level through the setting and maintaining of the transistor 32 in an off state in a period in which the output voltage Vout falls within the normal voltage range RNG_{NML}, and holds the signal Spg at a low level through the setting and maintaining of the transistor 32 in an on state in a period in which the output voltage Vout deviates from the normal voltage range RNG_{NML}.

However, in a period in which the switching of the transistor MH to an off state by the overcurrent protecting operation is performed repeatedly (the period will hereinafter be referred to as a second OCP duration) within the soft start period, the signal output circuit 30 performs an operation of outputting a specific signal Sb indicating that the overcurrent protecting operation is performed, as the signal Spg, from the power-good terminal PG, preferentially over the above-described basic operation. The specific signal Sb is a rectangular wave signal alternately having a high level and a low level. The period between times t_{B2} and t_{B3} in FIG. 8 is an example of the second OCP duration. Incidentally, the rectangular wave signal as the signal Spg may have a waveform rounded depending on the value of the pull-up resistor R3 and a capacitance added to the wiring WRpg (including a parasitic capacitance), for example.

In the second OCP duration, each time the transistor MH is switched from off to on with a rise edge in the signal SET as a trigger, the coil current IL (drain current of the transistor MH) reaches the limit current I_{LIM} through an increase in the on period of the transistor MH. Hence, in the second OCP duration, each time the state of the output stage circuit MM is switched from the output low state to the output high state, the overcurrent protecting operation switches the state of the output stage circuit MM from the output high state to the output low state irrespective of the signal RST (that is, irrespective of the switching control signal) after the switching to the output high state.

In the second OCP duration, even when the output voltage Vout deviates from the normal voltage range RNG_{NML} (even when “Vout<V_L” holds), the signal output circuit 30 outputs a rectangular wave signal alternately having a high level and a low level (hence the specific signal Sb), as the signal Spg, from the power-good terminal PG.

The specific signal Sb that can be output by the signal output circuit 30 in the second OCP duration may be a rectangular wave signal having a predetermined frequency f_{X}. The predetermined frequency f_{X} here may be any frequency set independently of the switching frequency of the output stage circuit MM, or may be a frequency proportional to the switching frequency of the output stage circuit MM. The same frequency as the switching frequency of the output stage circuit MM also belongs to frequencies proportional to the switching frequency of the output stage circuit MM.

In the example of FIG. 8, after setting the gate signal G₃₂ at a high level at a time between time t_{B0} and time t_{B1}, the output monitoring circuit 31 holds the signal Spg at a low level by holding the gate signal G₃₂ at the high level by the above-described basic operation until a time immediately before time t_{B2}. This is because “Vout<V_L” holds until time t_{B4}, which is after time t_{B2}, is reached. However, in the second OCP duration corresponding to the period between times t_{B2} and t_{B3}, the output monitoring circuit 31 according to the example of FIG. 8 generates a fall edge in the gate signal G₃₂ each time a rise edge occurs in the overcurrent protection signal S_{OCP}, and thereafter generates a rise edge in the gate signal G₃₂ when an off time Toff passes. Therefore, each time a rise edge occurs in the overcurrent protection signal S_{OCP}, the transistor 32 is turned off for the off time Toff, and the signal Spg thereby has a high level for the off time Toff. As a result, the specific signal Sb in the example of FIG. 8 is a rectangular wave signal having the same frequency as the switching frequency of the output stage circuit MM. The off time Toff may be a predetermined fixed time. Alternatively, a time for which the overcurrent protection signal S_{OCP} has a high level may be the off time Toff. However, suppose that the off time Toff is shorter than the switching cycle of the output stage circuit MM (in other words, a reciprocal of the switching frequency of the output stage circuit MM).

In the example of FIG. 8, after the gate signal G₃₂ is set to a low level for the off time Toff in response to a rise edge in the overcurrent protection signal S_{OCP} at time t_{B3}, the coil current IL is constantly maintained to be less than the limit current I_{LIM}, and thus, the overcurrent protection signal S_{OCP} is maintained at a low level. Therefore, after setting the gate signal G₃₂ to a low level for the off time Toff in response to the rise edge in the overcurrent protection signal S_{OCP} at time t_{B3}, the output monitoring circuit 31 holds the gate signal G₃₂ at a high level according to the above-described basic operation until time t_{B4} at which the output voltage Vout reaches the normal lower limit voltage V_L. At time t_{B4}, the output voltage Vout reaches the normal lower limit voltage V_L, and thus, the output monitoring circuit 31 generates a fall edge in the gate signal G₃₂. After time t_{B4}, the output voltage Vout falls within the normal voltage range RNG_{NML}, the output monitoring circuit 31 hence maintains the gate signal G₃₂ at a low level, and as a result, the signal Spg is maintained at a high level. However, if conditions as illustrated in FIG. 7 occur after time t_{B4}, the signal Spg can have a low level according to the method illustrated in the first example.

According to the method in the second example, whether the overcurrent protecting operation is exerted within the power supply control device 2 in the soft start period can be determined by referring to the signal Spg. Based on the determined content, the designer of the power supply device 1 can, for example, consider lowering the input voltage Vin or changing the capacitance of the output capacitor C1 such that the overcurrent protecting operation is not readily exerted. An improvement in convenience in the design of the power supply device 1 is consequently achieved.

### Third Example

A third example will be described. The signal output circuit 30 according to the third example can control the level of the signal Spg, based on the temperature detection signal Stmp. The temperature detection signal Stmp indicates whether or not the target temperature TMP belongs to a specific temperature range. When the target temperature TMP belongs to the specific temperature range, the signal output circuit 30 according to the third example outputs a specific signal Sc indicating that the target temperature TMP belongs to the specific temperature range, as the signal Spg, from the power-good terminal PG.

The specific temperature range is a composite range of the temperature ranges TRNG[1] to TRNG[n−1] (see FIG. 6). That is, the specific temperature range is a range equal to or higher than the temperature Tb[1] but lower than Tb[n].

As a basic operation related to the monitoring of the output voltage, the signal output circuit 30 holds the signal Spg at a high level through the setting and maintaining of the transistor 32 in an off state in a period in which the output voltage Vout falls within the normal voltage range RNG_{NML} and the target temperature TMP is lower than the specific temperature range, and the signal output circuit 30 holds the signal Spg at a low level through the setting and maintaining of the transistor 32 in an on state in a period in which the output voltage Vout deviates from the normal voltage range RNG_{NML} and the target temperature TMP is lower than the specific temperature range. The target temperature TMP being lower than the specific temperature range indicates that the target temperature TMP is lower than a lower limit temperature (Tb[1]) of the specific temperature range.

However, in a period in which the target temperature TMP belongs to the specific temperature range, the signal output circuit 30 performs an operation of outputting the specific signal Sc indicating that the target temperature TMP belongs to the specific temperature range, as the signal Spg, from the power-good terminal PG, preferentially over the above-described basic operation. In a period in which the target temperature TMP belongs to the specific temperature range, the signal output circuit 30 outputs the specific signal Sc as the signal Spg from the power-good terminal PG irrespective of the relation between the output voltage Vout and the normal voltage range RNG_{NML}.

In a period in which the target temperature TMP exceeds the specific temperature range, the signal output circuit 30 may hold the signal Spg at a low level through the setting and maintaining of the transistor 32 in an on state. Alternatively, in a period in which the target temperature TMP exceeds the specific temperature range, the signal output circuit 30 may set the level of the signal Spg, based on only the relation between the output voltage Vout and the normal voltage range RNG_{NML}. That is, in a period in which the target temperature TMP exceeds the specific temperature range, the signal output circuit 30 may hold the signal Spg at a high level through the setting and maintaining of the transistor 32 in an off state when the output voltage Vout belongs to the normal voltage range RNG_{NML}, and may hold the signal Spg at a low level through the setting and maintaining of the transistor 32 in an on state when the output voltage Vout deviates from the normal voltage range RNG_{NML}. The target temperature TMP exceeding the specific temperature range indicates that the target temperature TMP is higher than an upper limit temperature (Tb[n]) of the specific temperature range.

The specific signal Sc is a rectangular wave signal alternately having a high level and a low level. Incidentally, the rectangular wave signal as the signal Spg may have a waveform rounded depending on the value of the pull-up resistor R3 and a capacitance added to the wiring WRpg (including a parasitic capacitance), for example.

There are (n−1) types of specific signals Sc. The (n−1) types of specific signals Sc will be referred to as specific signals Sc[1] to Sc[n−1]. The specific signals Sc[1] to Sc[n−1] are rectangular wave signals that have frequencies different from each other. For any freely-selected natural number i, the frequency of the specific signal Sc[i+1] is lower than the frequency of the specific signal Sc[i] (however, a modification is also possible in which the frequency of the specific signal Sc[i+1] is made higher than the frequency of the specific signal Sc[i]). For the freely-selected natural number i, when the target temperature TMP belongs to the temperature range TRNG[i], the signal output circuit 30 outputs the specific signal Sc[i] as the signal Spg from the power-good terminal PG.

The respective frequencies of the specific signals Sc[1] to Sc[n−1] are frequencies proportional to the switching frequency of the output stage circuit MM. The same frequency as the switching frequency of the output stage circuit MM also belongs to the frequencies proportional to the switching frequency of the output stage circuit MM. However, the respective frequencies of the specific signals Sc[1] to Sc[n−1] may be freely-selected frequencies set independently of the switching frequency of the output stage circuit MM.

The signal output circuit 30 may generate the specific signals Sc[1] to Sc[n−1] by frequency-dividing the clock signal CLK. As described above, the frequency of the clock signal CLK is the reference frequency fref. For example, in the case where the switching frequency of the output stage circuit MM is equal to the reference frequency fref, the signal output circuit 30 may set the frequency of the specific signal Sc[1] at ½ of the reference frequency fref (that is, fref/2), and set the frequency of the specific signal Sc[2] at ¼ of the reference frequency fref (that is, fref/4).

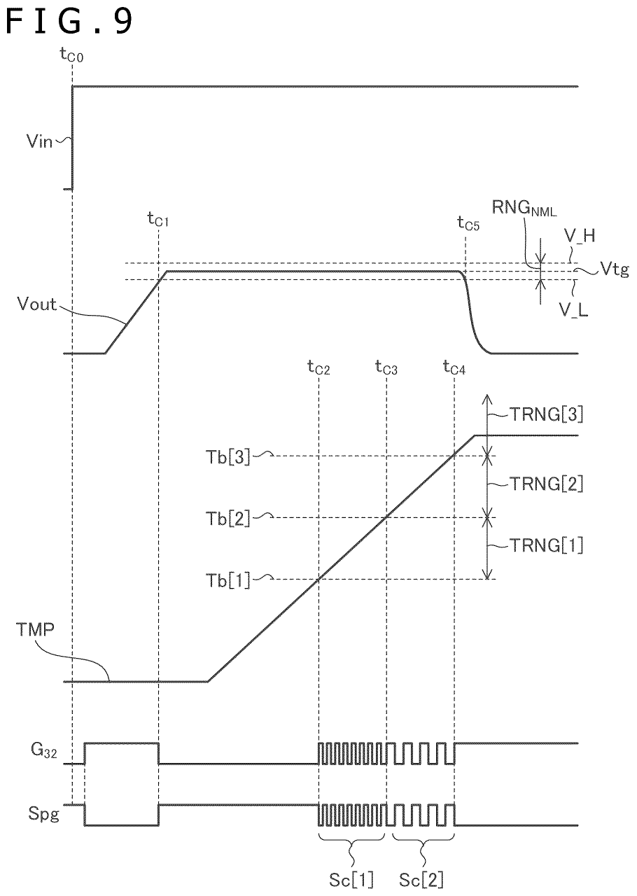

An operation of outputting the signal Spg according to the target temperature TMP will be described with reference to FIG. 9. Suppose that, in the example of FIG. 9, times t_{C0}, t_{C1}, t_{C2}, t_{C3}, t_{C4}, and t_{C5} arrive in this order with the progress of time. In addition, suppose that “n=3” in the example of FIG. 9. Hence, in the example of FIG. 9, the specific temperature range is a composite range of the temperature ranges TRNG[1] and TRNG[2].

The supply of the input voltage Vin to the input terminal IN is shut off before time t_{C0}. The supply of the input voltage Vin to the input terminal IN is started from time t_{C0}. After time t_{C0}, the input voltage Vin supplied to the input terminal IN is sufficiently higher than the target voltage Vtg. The power supply control device 2 is started at time t_{C0}, and a predetermined initial sequence operation is performed within the power supply control device 2 from time t_{C0}. In the initial sequence operation, the output monitoring circuit 31 sets the transistor 32 to on by setting the level of the gate signal G₃₂ to a high level. Because the transistor 32 is set to on, the signal Spg has a low level. Thereafter, the switching control of the output stage circuit MM is started, and the soft start function described in the second example gradually raises the output voltage Vout to the target voltage Vtg. The output voltage Vout reaches the normal lower limit voltage V_L at time t_{C1}. In response to this, the signal output circuit 30 generates a rise edge in the signal Spg by generating a fall edge in the gate signal G₃₂.

The target temperature TMP is lower than the temperature Tb[1] until a time immediately before time t_{C2}. In addition, the output voltage Vout belongs to the normal voltage range RNG_{NML} from time t_{C1} to time t_{C5}. The output monitoring circuit 31 therefore holds the signal Spg at a high level by holding the level of the gate signal G₃₂ at a low level according to the above-described basic operation from time t_{C1} to a time immediately before time t_{C2}.

In the example of FIG. 9, the target temperature TMP belongs to the temperature range TRNG[1] from time t_{C2} to a time immediately before time t_{C3}, the target temperature TMP belongs to the temperature range TRNG[2] from time t_{C3} to a time immediately before time t_{C4}, and the target temperature TMP belongs to the temperature range TRNG[3] at and after time t_{C4}. Hence, the signal output circuit 30 outputs the specific signal Sc[1] as the signal Spg from the power-good terminal PG from time t_{C2} to a time immediately before time t_{C3}, and outputs the specific signal Sc[2] as the signal Spg from the power-good terminal PG from time t_{C3} to a time immediately before time t_{C4}.

In a case where the frequency of the specific signal Sc[1] is set at a frequency (fref/2), the output monitoring circuit 31 repeats an operation of switching the gate signal G₃₂ between a high level and a low level at the frequency (fref/2) and thereby outputs a rectangular wave signal of the frequency (fref/2) as the specific signal Sc[1] and the signal Spg from the power-good terminal PG from time t_{C2} to a time immediately before time t_{C3}. In a case where the frequency of the specific signal Sc[2] is set at the frequency (fref/4), the output monitoring circuit 31 repeats an operation of switching the gate signal G₃₂ between a high level and a low level at the frequency (fref/4) and thereby outputs a rectangular wave signal of the frequency (fref/4) as the specific signal Sc[2] and the signal Spg from the power-good terminal PG from time t_{C3} to a time immediately before time t_{C4}.

The temperature detection signal Stmp is supplied also to the switching control circuit 10. The switching control circuit 10 performs a shutdown operation when the temperature detection signal Stmp indicates that the target temperature TMP is equal to or higher than the temperature Tb[n] (that is, the target temperature TMP belongs to the temperature range TRNG[n]). In the shutdown operation, the switching control circuit 10 stops the switching control of the output stage circuit MM, and holds the output stage circuit MM in the double off state. In the example of FIG. 9 in which “n=3” is assumed, at time t_{C4}, the target temperature TMP reaches the temperature Tb[n], and hence, the shutdown operation stops the switching control. As a result, the output voltage Vout rapidly decreases to 0 V. The output voltage Vout becomes lower than the normal lower limit voltage V_L at time t_{C5} in a process in which the output voltage Vout decreases. When the target temperature TMP belongs to the temperature range TRNG[n], the signal output circuit 30 may set the signal Spg at a low level by setting a high level in the gate signal G₃₂. Alternatively, the signal output circuit 30 may set the signal Spg at a low level through the setting of a high level in the gate signal G₃₂ in response to the output voltage Vout becoming lower than the normal lower limit voltage V_L in the process in which the output voltage Vout decreases due to the shutdown operation performed based on the belonging of the target temperature TMP to the temperature range TRNG[n].

Though not particularly illustrated in FIG. 9, the switching control circuit 10 may resume the switching control when the stopping of the switching control by the shutdown operation decreases the target temperature TMP to a temperature (Tb[3]−ΔHYS) or lower. The temperature (Tb[3]−ΔHYS) is lower than the temperature Tb[3] by a predetermined hysteresis temperature (for example, 25° C.). While the behavior of the signal Spg in a rising process of the target temperature TMP has been described with reference to FIG. 9, the behavior of the signal Spg in a falling process of the target temperature TMP may also be similar. Specifically, for example, in either of the rising process and the falling process of the target temperature TMP, in a period in which the target temperature TMP belongs to the temperature range TRNG[2], the signal output circuit 30 may repeat the operation of switching the gate signal G₃₂ between a high level and a low level at the frequency (fref/4), and thereby output a rectangular wave signal of the frequency (fref/4) as the specific signal Sc[2] and the signal Spg from the power-good terminal PG. Similarly, for example, in either of the rising process and the falling process of the target temperature TMP, in a period in which the target temperature TMP belongs to the temperature range TRNG[1], the signal output circuit 30 may repeat the operation of switching the gate signal G₃₂ between a high level and a low level at the frequency (fref/2), and thereby output a rectangular wave signal of the frequency (fref/2) as the specific signal Sc[1] and the signal Spg from the power-good terminal PG.

According to the method in the third example, whether the temperature within the power supply control device 2 is abnormally raised and how much the temperature within the power supply control device 2 is raised can be determined by referring to the signal Spg. The designer of the power supply device 1 can utilize the determined content in thermal margin design and other designs. An improvement in convenience in the design of the power supply device 1 is consequently achieved.

In addition, the processor 3 may change the switching frequency of the output stage circuit MM based on the specific signal Sc. The external synchronization terminal CIN is used for this. The external synchronization terminal CIN can be constantly provided with the ground potential by being connected to the ground in the power supply device 1 in advance. In a case where the external synchronization terminal CIN is not supplied with a rectangular wave signal having a certain frequency, such as a case where the external synchronization terminal CIN is provided with the ground potential, the switching control circuit 10 performs the switching control of the output stage circuit MM in synchronism with the clock signal CLK, and hence, the switching frequency of the output stage circuit MM coincides with the reference frequency fref as the frequency of the clock signal CLK.

However, in the power supply device 1, the processor 3 may be connected to the external synchronization terminal CIN in advance, and may provide the external synchronization terminal CIN with the ground potential or an external synchronizing signal. At this time, the processor 3 may fix the potential of the external synchronization terminal CIN at the ground potential in a period in which the specific signal Sc is not output as the signal Spg, and may provide the external synchronization terminal CIN with the external synchronizing signal in a period in which the specific signal Sc is output as the signal Spg. Here, the external synchronizing signal is a rectangular wave signal alternately having a high level (level of the power supply voltage VDD) and a low level (level of the ground). In the period in which the external synchronizing signal is supplied to the external synchronization terminal CIN, the switching control circuit 10 performs the switching control of the output stage circuit MM in synchronism with the external synchronizing signal. When the switching control of the output stage circuit MM is performed in synchronism with the external synchronizing signal, the switching frequency of the output stage circuit MM coincides with the frequency of the external synchronizing signal. In the period in which the external synchronizing signal is supplied to the external synchronization terminal CIN, it suffices for the switching control circuit 10 to generate a rise edge in the signal SET in synchronism with a rise edge of the external synchronizing signal each time the rise edge occurs in the external synchronizing signal, or it suffices for the switching control circuit 10 to generate a rise edge in the signal SET in synchronism with a fall edge of the external synchronizing signal each time the fall edge occurs in the external synchronizing signal.

The processor 3 may supply the external synchronizing signal having a first frequency to the external synchronization terminal CIN in a period in which the processor 3 receives the specific signal Sc[1] as the signal Spg. Here, the first frequency may be lower than the reference frequency fref as the frequency of the clock signal CLK, and may be the same as the frequency of the specific signal Sc[1] (that is, fref/2, for example). Therefore, the supply of the external synchronizing signal having the first frequency to the external synchronization terminal CIN decreases the switching frequency from the reference frequency fref, and a decrease in the target temperature TMP is expected through a reduction in a switching loss. The processor 3 may supply the external synchronizing signal having a second frequency to the external synchronization terminal CIN, in a period of receiving the specific signal Sc[2] as the signal Spg. Here, the second frequency may be even lower than the above-described first frequency, and may be the same as the frequency of the specific signal Sc[2] (that is, fref/4, for example). Therefore, the supply of the external synchronizing signal having the second frequency to the external synchronization terminal CIN decreases the switching frequency from the reference frequency fref and the first frequency, and a decrease in the target temperature TMP is expected through a reduction in the switching loss.

### Fourth Example

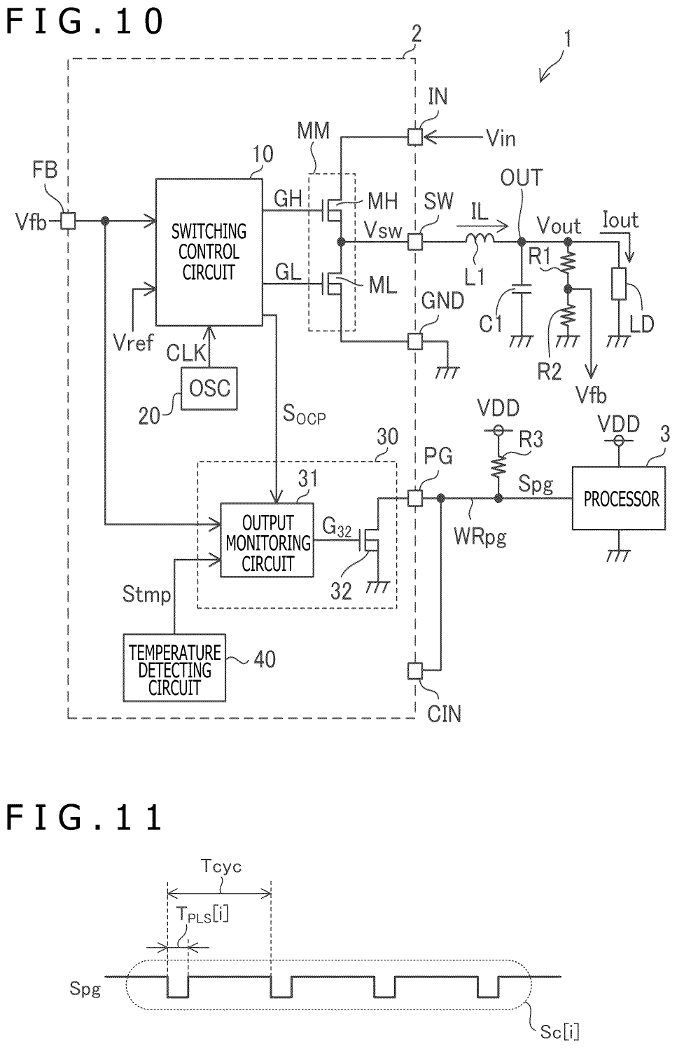

A fourth example will be described. In the fourth example, as illustrated in FIG. 10, the external synchronization terminal CIN is connected to the wiring WRpg on the outside of the power supply control device 2, and the signal Spg is thereby supplied to the external synchronization terminal CIN. As described in the third example, in a case where the external synchronization terminal CIN is not supplied with a rectangular wave signal having a certain frequency, such as a case where the external synchronization terminal CIN is provided with the ground potential, the switching control circuit 10 performs the switching control of the output stage circuit MM in synchronism with the clock signal CLK, and the switching frequency of the output stage circuit MM thereby coincides with the reference frequency fref as the frequency of the clock signal CLK. In a period in which the external synchronizing signal is supplied to the external synchronization terminal CIN, the switching control circuit 10 performs the switching control of the output stage circuit MM in synchronism with the external synchronizing signal. When the switching control of the output stage circuit MM is performed in synchronism with the external synchronizing signal, the switching frequency of the output stage circuit MM coincides with the frequency of the external synchronizing signal. In the period in which the external synchronizing signal is supplied to the external synchronization terminal CIN, it suffices for the switching control circuit 10 to generate a rise edge in the signal SET in synchronism with a rise edge of the external synchronizing signal each time the rise edge occurs in the external synchronizing signal, or it suffices for the switching control circuit 10 to generate a rise edge in the signal SET in synchronism with a fall edge of the external synchronizing signal each time the fall edge occurs in the external synchronizing signal.

In the fourth example, only in a period in which the specific signal Sc is output from the power-good terminal TG, the specific signal Sc is supplied as the external synchronizing signal to the external synchronization terminal CIN.

Hence, with regard to the example of FIG. 9, in a period in which the specific signal Sc[1] is output from the power-good terminal TG, the switching control circuit 10 sets the switching frequency of the output stage circuit MM at the frequency of the specific signal Sc[1] (that is, fref/2, for example) by performing the switching control of the output stage circuit MM in synchronism with the specific signal Sc[1]. In the period in which the specific signal Sc[1] is output from the power-good terminal TG, it suffices to generate a rise edge in the signal SET in synchronism with a rise edge of the specific signal Sc[1] each time the rise edge occurs in the specific signal Sc[1](hence the signal Spg), or it suffices to generate a rise edge in the signal SET in synchronism with a fall edge of the specific signal Sc[1] each time the fall edge occurs in the specific signal Sc[1]. When the switching frequency of the output stage circuit MM is set at the frequency of the specific signal Sc[1], the switching frequency is decreased from the reference frequency fref, and a decrease in the target temperature TMP is expected through a reduction in the switching loss.

Similarly, with regard to the example of FIG. 9, in a period in which the specific signal Sc[2] is output from the power-good terminal TG, the switching control circuit 10 sets the switching frequency of the output stage circuit MM at the frequency of the specific signal Sc[2](that is, fref/4, for example) by performing the switching control of the output stage circuit MM in synchronism with the specific signal Sc[2]. In the period in which the specific signal Sc[2] is output from the power-good terminal TG, it suffices to generate a rise edge in the signal SET in synchronism with a rise edge of the specific signal Sc[2] each time the rise edge occurs in the specific signal Sc[2](hence the signal Spg), or it suffices to generate a rise edge in the signal SET in synchronism with a fall edge of the specific signal Sc[2] each time the fall edge occurs in the specific signal Sc[2]. When the switching frequency of the output stage circuit MM is set at the frequency of the specific signal Sc[2], the switching frequency is decreased from the reference frequency fref and the frequency of the specific signal Sc[1], and a decrease in the target temperature TMP is expected through a reduction in the switching loss.

### Fifth Example

A fifth example will be described. In the fifth example, the specific signal Sc may be a pulse width modulated signal. That is, when the target temperature TMP belongs to the temperature range TRNG[i], the signal output circuit 30 may output a specific signal Sc[i] illustrated in FIG. 11 as the signal Spg from the power-good terminal PG.

The specific signal Sc[i] illustrated in FIG. 11 is a pulse width modulated signal having a pulse width T_{PLS}[i]. The cycle of the specific signal Sc[i] illustrated in FIG. 11 is a cycle Tcyc. The cycle Tcyc may have a predetermined length. The specific signal Sc[i] illustrated in FIG. 11 is a pulse width modulated signal that has a low level for the pulse width T_{PLS}[i] in each cycle Tcyc and has a high level for a time shorter by the pulse width T_{PLS}[i] than the length of one cycle Tcyc. However, a pulse width modulated signal that has a high level for the pulse width T_{PLS}[i] in each cycle Tcyc and has a low level for a time shorter by the pulse width T_{PLS}[i] than the length of one cycle Tcyc may be set as the specific signal Sc[i].

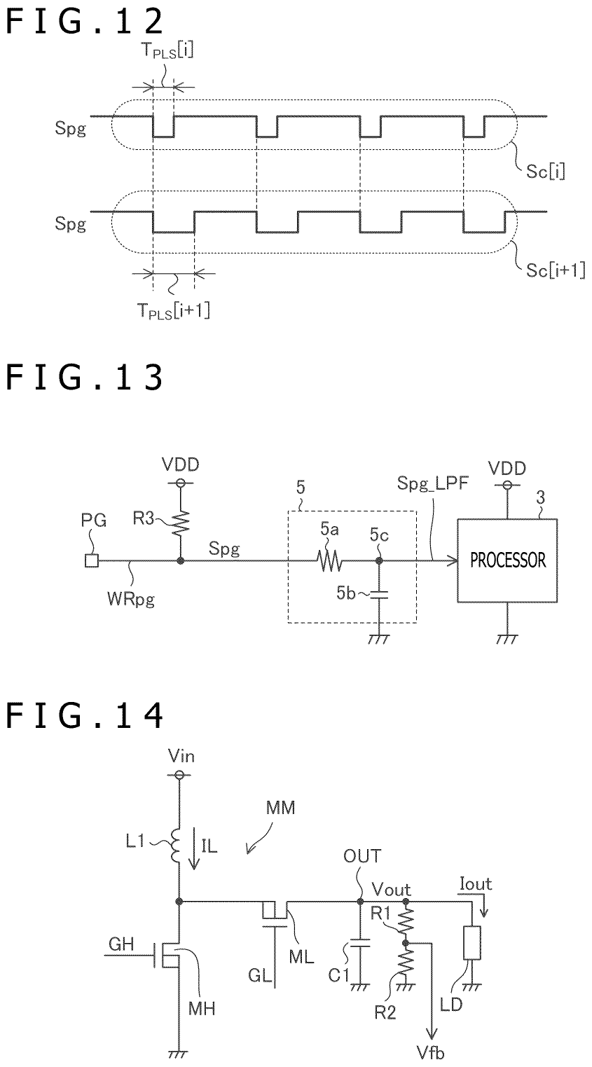

The pulse widths T_{PLS}[1] to T_{PLS}[n] of the specific signals Sc[1] to Sc[n] are different from each other. Hence, based on the signal in the wiring WRpg, the processor 3 can determine the presence or absence of output of the specific signal Sc from the power-good terminal PG, and can determine which of the specific signals Sc[1] to Sc[n] the specific signal Sc is when the specific signal Sc is output from the power-good terminal PG. For example, for any integer i, the pulse width TPLS[i+1] is longer than the pulse width T_{PLS}[i], as illustrated in FIG. 12. However, the pulse width T_{PLS}[i+1] may be made shorter than the pulse width T_{PLS}[i].

As illustrated in FIG. 13, a low-pass filter 5 may be provided in advance on wiring connecting the power-good terminal PG and the processor 3 to each other, and a signal Spg_LPF obtained by allowing only a low range frequency component among signal components of the signal Spg to pass through the low-pass filter 5 may be input to the processor 3. In a configuration illustrated in FIG. 13, the low-pass filter 5 includes a resistance 5a and a capacitor 5b. The first end of the pull-up resistor R3 is connected to the application terminal of the power supply voltage VDD. The second end of the pull-up resistor R3 is connected to the wiring WRpg and the power-good terminal PG, and is connected to a first end of the resistance 5a. A second end of the resistance 5a is connected at a node Sc to a first end of the capacitor 5b. A second end of the capacitor 5b is connected to the ground. A signal at the power-good terminal PG is the signal Spg. A signal at the node Sc is the signal Spg_LPF. The signal Spg_LPF is a direct-current voltage signal that essentially has an average voltage value of the signal Spg. Based on the level (voltage value) of the signal Spg_LPF, the processor 3 can determine the presence or absence of output of the specific signal Sc from the power-good terminal PG, and can determine which of the specific signals Sc[1] to Sc[n] the specific signal Sc is when the specific signal Sc is output from the power-good terminal PG.

### Sixth Example

A sixth example will be described.

The power supply device 1 in FIG. 1 is a step-down switching power supply apparatus (switching regulator). However, the power supply device 1 may be a step-up switching power supply apparatus. The step-up switching power supply apparatus generates the output voltage Vout higher than the input voltage Vin by stepping up the input voltage Vin. FIG. 14 is a partial configuration diagram of the power supply device 1 in a case where the power supply device 1 is a step-up switching power supply apparatus. In the case where the power supply device 1 is a step-up switching power supply apparatus, as illustrated in FIG. 14, the first end of the coil L1 is connected to the application terminal of the input voltage Vin (terminal to which the input voltage Vin is applied), the second end of the coil L1 is connected to the drain of the transistor MH and the source of the transistor ML, the source of the transistor MH is connected to the ground, and the drain of the transistor ML is connected to the output terminal OUT, and is connected to the ground via the output capacitor C1. Further, the switching control circuit 10 performs the switching control of the output stage circuit MM such that the feedback voltage Vfb coincides with the reference voltage Vref (transistors MH and ML are alternately turned on and off). However, in the soft start period, the switching control circuit 10 performs the switching control of the output stage circuit MM such that the feedback voltage Vfb coincides with the voltage Vss (transistors MH and ML are alternately turned on and off). Incidentally, in the configuration of FIG. 14, the transistor ML as the rectifying element may be replaced with a synchronous rectifier diode that has an anode connected to the drain of the transistor MH and a cathode connected to the output terminal OUT. In either case, the output voltage Vout is generated based on the current (IL) flowing through the coil L1 by switching the output transistor (MH) between on and off in the switching control of the output stage circuit MM. The power supply device 1 may be a step-up/down switching power supply apparatus.

The power supply device 1 can be mounted in any electric apparatus. A power supply system as a whole including the power supply device 1 and the processor 3 can be mounted in any electric apparatus. The electric apparatus may be an electric apparatus mounted in a vehicle such as an automobile, may be a computer device, or may be a household electric appliance or an industrial apparatus.

With regard to any signal or voltage, the relation between the high level and the low level thereof can be opposite to the foregoing in a form that does not impair the above-described spirit.

The types of channels of the FETs illustrated in the foregoing embodiment are illustrative. The type of channel of any freely-selected FET can be changed between the P-channel type and the N-channel type in a form that does not impair the above-described spirit.

Unless an inconvenience occurs, the above-described freely-selected transistor may be a transistor of any type. For example, the freely-selected transistor described above as a MOSFET can be replaced with a junction FET, an insulated gate bipolar transistor (IGBT), or a bipolar transistor unless an inconvenience occurs. The freely-selected transistor has a first electrode, a second electrode, and a control electrode. In a FET, one of the first and second electrodes is a drain, the other is a source, and the control electrode is a gate. In an IGBT, one of the first and second electrodes is a collector, the other is an emitter, and the control electrode is a gate. In a bipolar transistor not belonging to the IGBT, one of the first and second electrodes is a collector, the other is an emitter, and the control electrode is a base.

The embodiments of the present disclosure can be modified in various manners as appropriate within the scope of technical ideas illustrated in claims. The above embodiments are merely an example of embodiments of the present disclosure, and the meanings of terms of the present disclosure or respective constituent elements are not limited to those described in the above embodiments. Specific numerical values illustrated in the foregoing description are merely illustrative, and the numerical values can of course be changed to various numerical values.

### <<Supplementary Notes>>

Supplementary notes will be provided for the present disclosure whose specific configuration examples have been illustrated in the foregoing embodiments.

A power supply control device according to one example of the present disclosure (see the first and second examples) is a power supply control device (2) provided in a switching power supply apparatus (1) configured to convert an input voltage (Vin) into an output voltage (Vout) through switching of an output transistor (MH), the power supply control device (2) including a switching control circuit (10) configured to stabilize the output voltage by performing switching control of the output transistor, based on a feedback voltage (Vfb) corresponding to the output voltage, a signal output terminal (PG), and a signal output circuit (30) configured to be capable of outputting a signal corresponding to whether or not the output voltage is normal from the signal output terminal, based on the feedback voltage, the switching control circuit being configured to be capable of performing an overcurrent protecting operation that limits a current flowing through the output transistor to a limit current (I_{LIM}) or less, and the signal output circuit outputting a specific signal (Sa, Sb) indicating the execution of the overcurrent protecting operation from the signal output terminal when the current flowing through the output transistor reaches the limit current (first configuration).

According to the first configuration, whether the overcurrent protecting operation is exerted within the power supply control device can be determined in a device external to the power supply control device. In this case, the output of the specific signal indicating the execution of the overcurrent protecting operation is made possible in advance by use of the signal output terminal originally provided for monitoring the output voltage. It is thereby possible to suppress increases in the size and cost of parts which accompany the installation of a dedicated terminal.

In the power supply control device according to the foregoing first configuration, in a period in which the current flowing through the output transistor reaches the limit current each time the output transistor is set to on in the switching control, the signal output circuit may output a signal having a predetermined frequency as the specific signal from the signal output terminal (second configuration).

In the power supply control device according to the foregoing second configuration, in the period in which the current flowing through the output transistor reaches the limit current each time the output transistor is set to on in the switching control, the signal output circuit may output a signal having the same frequency as a switching frequency of the output transistor as the specific signal from the signal output terminal (third configuration).

In the power supply control device according to the foregoing first configuration (see FIG. 7 or FIG. 8), the switching control circuit may alternately turn on and off the output transistor in the switching control, and switch the output transistor to off by the overcurrent protecting operation when the current flowing through the output transistor reaches the limit current in a state in which the switching control circuit controls the output transistor to on in the switching control, and the signal output circuit may set a level of the signal of the signal output terminal to one of two levels, and output the specific signal from the signal output terminal by performing an operation of returning the level of the signal of the signal output terminal to one level of the two levels after switching the level of the signal of the signal output terminal from the one level to the other level each time the output transistor is switched to off by the overcurrent protecting operation (fourth configuration).

In the power supply control device according to any one of the foregoing first to third configurations (see FIG. 7), the signal output circuit may output a signal having a first level from the signal output terminal in a period in which the output voltage falls within a normal voltage range and the current flowing through the output transistor is maintained to be smaller than the limit current, and may output a signal having a second level from the signal output terminal in a period in which the output voltage deviates from the normal voltage range and the current flowing through the output transistor is maintained to be smaller than the limit current, and the signal output circuit may output a rectangular wave signal alternately having the first level and the second level as the specific signal (Sa) from the signal output terminal in a period in which the current flowing through the output transistor reaches the limit current each time the output transistor is set to on in the switching control (for example, the period between times t_{A2} and t_{A3}) (fifth configuration).

In the power supply control device according to any one of the foregoing first to third configurations (see FIG. 8), the signal output circuit may output a rectangular wave signal alternately having a first level and a second level as the specific signal (Sb) from the signal output terminal in a period in which the output voltage is lower than a lower limit voltage (V_L) of a normal voltage range in a rising process of the output voltage to a target voltage of the output voltage and the current flowing through the output transistor reaches the limit current each time the output transistor is set to on in the switching control (for example, the period between times t_{B2} and t_{B3}), and the signal output circuit may output a signal having one of the first level and the second level from the signal output terminal in a period in which the output voltage is lower than the lower limit voltage of the normal voltage range in the rising process and the current flowing through the output transistor is maintained to be smaller than the limit current (for example, the period between times t_{B1} and t_{B2}) (sixth configuration).

A power supply control device according to another example of the present disclosure (see the third to fifth examples) is a power supply control device (2) provided in a switching power supply apparatus (1) configured to convert an input voltage (Vin) into an output voltage (Vout) through switching of an output transistor (MH), the power supply control device (2) including a switching control circuit (10) configured to stabilize the output voltage by performing switching control of the output transistor, based on a feedback voltage (Vfb) corresponding to the output voltage, a signal output terminal (PG), a signal output circuit (30) configured to be capable of outputting a signal corresponding to whether or not the output voltage is normal from the signal output terminal, based on the feedback voltage, and a temperature detecting circuit (40) configured to detect whether a target temperature (TMP) within the power supply control device belongs to a specific temperature range (TRNG[1] to TRNG[n−1]), the signal output circuit outputting a specific signal (Sc) indicating that the target temperature belongs to the specific temperature range from the signal output terminal when the target temperature belongs to the specific temperature range (seventh configuration).

According to the seventh configuration, whether the target temperature belongs to the specific temperature range within the power supply control device can be determined in a device external to the power supply control device. In this case, the output of the specific signal indicating that the target temperature belongs to the specific temperature range is made possible in advance by use of the signal output terminal originally provided for monitoring the output voltage. It is thereby possible to suppress increases in size and cost of parts which accompany the installation of a dedicated terminal.

In the power supply control device according to the foregoing seventh configuration (see FIG. 9 and other relevant figures), the specific temperature range may be a composite temperature range of a plurality of temperature ranges including a first temperature range (TRNG[1]) and a second temperature range (TRNG[2]) higher than the first temperature range, the temperature detecting circuit may detect to which of the plurality of temperature ranges the target temperature belongs, and the signal output circuit may output a first specific signal (Sc[1]) as the specific signal from the signal output terminal when the target temperature belongs to the first temperature range, and output a second specific signal (Sc[2]) different from the first specific signal, as the specific signal from the signal output terminal, when the target temperature belongs to the second temperature range (eighth configuration).

It is thereby possible to determine, in a device external to the power supply control device, a temperature range to which the target temperature belongs from among the plurality of temperature ranges constituting the specific temperature range.

In the power supply control device according to the foregoing eighth configuration, the first specific signal and the second specific signal may be signals having frequencies proportional to a switching frequency of the output transistor, and the frequency of the first specific signal and the frequency of the second specific signal may be different from each other (ninth configuration).

In the power supply control device according to the foregoing ninth configuration, the switching frequency may be equal to a reference frequency (fref) in a state in which the target temperature is lower than a lower limit of the first temperature range, the frequency of the first specific signal may be lower than the reference frequency, and the frequency of the second specific signal may be even lower than the frequency of the first specific signal (tenth configuration).

The power supply control device according to the foregoing tenth configuration further includes an external synchronization terminal (CIN), the switching control circuit may, in a state in which the output signal of the signal output circuit is input to the external synchronization terminal (see FIG. 10), set the switching frequency to the frequency of the first specific signal by performing the switching control in synchronism with the first specific signal when the first specific signal is output from the signal output terminal, and may set the switching frequency to the frequency of the second specific signal by performing the switching control in synchronism with the second specific signal when the second specific signal is output from the signal output terminal (eleventh configuration).

When the first or second specific signal is output from the signal output terminal, the switching control is performed in synchronism with the first or second specific signal, and a decrease in the target temperature is thereby expected through a reduction in a switching loss.

In the power supply control device according to one of the foregoing seventh to eleventh configurations, the signal output circuit may output a signal having a first level (for example, a signal having a high level) from the signal output terminal in a period in which the output voltage falls within a normal voltage range and the target temperature is lower than the specific temperature range, and may output a signal having a second level (for example, a signal having a low level) from the signal output terminal in a period in which the output voltage deviates from the normal voltage range and the target temperature is lower than the specific temperature range, and the signal output circuit may output a rectangular wave signal alternately having the first level and the second level as the specific signal from the signal output terminal irrespective of relation between the output voltage and the normal voltage range when the target temperature belongs to the specific temperature range (twelfth configuration).

What is claimed is:

1. A power supply control device provided in a switching power supply apparatus configured to convert an input voltage into an output voltage through switching of an output transistor, the power supply control device comprising:
a switching control circuit configured to stabilize the output voltage by performing switching control of the output transistor, based on a feedback voltage corresponding to the output voltage;
a signal output terminal; and
a signal output circuit configured to be capable of outputting a signal corresponding to whether or not the output voltage is normal from the signal output terminal, based on the feedback voltage,
the switching control circuit being configured to be capable of performing an overcurrent protecting operation that limits a current flowing through the output transistor to a limit current or less, and
the signal output circuit outputting a specific signal indicating execution of the overcurrent protecting operation from the signal output terminal when the current flowing through the output transistor reaches the limit current.

2. The power supply control device according to claim 1, wherein,
in a period in which the current flowing through the output transistor reaches the limit current each time the output transistor is set to on in the switching control, the signal output circuit outputs a signal having a predetermined frequency as the specific signal from the signal output terminal.

3. The power supply control device according to claim 2, wherein,
in the period in which the current flowing through the output transistor reaches the limit current each time the output transistor is set to on in the switching control, the signal output circuit outputs a signal having a same frequency as a switching frequency of the output transistor as the specific signal from the signal output terminal.

4. The power supply control device according to claim 1, wherein
the switching control circuit alternately turns on and off the output transistor in the switching control, and switches the output transistor to off by the overcurrent protecting operation when the current flowing through the output transistor reaches the limit current in a state in which the switching control circuit is controlling the output transistor to on in the switching control, and
the signal output circuit sets a level of the signal of the signal output terminal to one of two levels, and outputs the specific signal from the signal output terminal by performing an operation of returning the level of the signal of the signal output terminal to one level of the two levels after switching the level of the signal of the signal output terminal from the one level to the other level each time the output transistor is switched to off by the overcurrent protecting operation.

5. The power supply control device according to claim 1, wherein
the signal output circuit outputs a signal having a first level from the signal output terminal in a period in which the output voltage falls within a normal voltage range and the current flowing through the output transistor is maintained to be smaller than the limit current, and outputs a signal having a second level from the signal output terminal in a period in which the output voltage deviates from the normal voltage range and the current flowing through the output transistor is maintained to be smaller than the limit current, and
the signal output circuit outputs a rectangular wave signal alternately having the first level and the second level as the specific signal from the signal output terminal in a period in which the current flowing through the output transistor reaches the limit current each time the output transistor is set to on in the switching control.

6. The power supply control device according to claim 1, wherein
the signal output circuit outputs a rectangular wave signal alternately having a first level and a second level as the specific signal from the signal output terminal in a period in which the output voltage is lower than a lower limit voltage of a normal voltage range in a rising process of the output voltage to a target voltage of the output voltage and the current flowing through the output transistor reaches the limit current each time the output transistor is set to on in the switching control, and
the signal output circuit outputs a signal having one of the first level and the second level from the signal output terminal in a period in which the output voltage is lower than the lower limit voltage of the normal voltage range in the rising process and the current flowing through the output transistor is maintained to be smaller than the limit current.

7. A power supply control device provided in a switching power supply apparatus configured to convert an input voltage into an output voltage through switching of an output transistor, the power supply control device comprising:
a switching control circuit configured to stabilize the output voltage by performing switching control of the output transistor, based on a feedback voltage corresponding to the output voltage;
a signal output terminal;
a signal output circuit configured to be capable of outputting a signal corresponding to whether or not the output voltage is normal from the signal output terminal, based on the feedback voltage; and
a temperature detecting circuit configured to detect whether a target temperature within the power supply control device belongs to a specific temperature range,
the signal output circuit outputting a specific signal indicating that the target temperature belongs to the specific temperature range from the signal output terminal when the target temperature belongs to the specific temperature range.

8. The power supply control device according to claim 7, wherein
the specific temperature range is a composite temperature range of a plurality of temperature ranges including a first temperature range and a second temperature range higher than the first temperature range,
the temperature detecting circuit detects to which of the plurality of temperature ranges the target temperature belongs, and
the signal output circuit outputs a first specific signal as the specific signal from the signal output terminal when the target temperature belongs to the first temperature range, and outputs a second specific signal different from the first specific signal as the specific signal from the signal output terminal when the target temperature belongs to the second temperature range.

9. The power supply control device according to claim 8, wherein
the first specific signal and the second specific signal are signals having frequencies proportional to a switching frequency of the output transistor, and the frequency of the first specific signal and the frequency of the second specific signal are different from each other.

10. The power supply control device according to claim 9, wherein
the switching frequency is equal to a reference frequency in a state in which the target temperature is lower than a lower limit of the first temperature range, and
the frequency of the first specific signal is lower than the reference frequency, and the frequency of the second specific signal is even lower than the frequency of the first specific signal.

11. The power supply control device according to claim 10, further comprising:
an external synchronization terminal, wherein,
the switching control circuit sets, in a state in which the output signal of the signal output circuit is input to the external synchronization terminal, the switching frequency to the frequency of the first specific signal by performing the switching control in synchronism with the first specific signal when the first specific signal is output from the signal output terminal, and sets the switching frequency to the frequency of the second specific signal by performing the switching control in synchronism with the second specific signal when the second specific signal is output from the signal output terminal.

12. The power supply control device according to claim 7, wherein
the signal output circuit outputs a signal having a first level from the signal output terminal in a period in which the output voltage falls within a normal voltage range and the target temperature is lower than the specific temperature range, and outputs a signal having a second level from the signal output terminal in a period in which the output voltage deviates from the normal voltage range and the target temperature is lower than the specific temperature range, and
the signal output circuit outputs a rectangular wave signal alternately having the first level and the second level as the specific signal from the signal output terminal irrespective of a relation between the output voltage and the normal voltage range when the target temperature belongs to the specific temperature range.
